(19) United States
(12) Patent Application Publication
(10) Pub. No.: US 2002/0028757 A1
(43) Pub. Date: Mar. 7, 2002

(54) Process of treating fabrics with a detergent tablet comprising an ion exchange resin

(75) Inventors: Andrea Esposito, Rome (IT); Valerio Del Duca, Rome (IT); Silvia Zanazzi, Perugia (IT)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(73) Assignee: The Procter & Gamble Company

(21) Appl. No.: 09/876,485

(22) Filed: Jun. 7, 2001

(30) Foreign Application Priority Data
Jun. 9, 2000 (EP) 00870123.7

(51) Int. Cl. C11D 17/06; C11D 7/42; C11D 7/54

(52) U.S. Cl. 510/446; 510/447; 510/392; 510/311

(57) ABSTRACT

A process of treating fabrics which comprises the steps of forming an aqueous bath comprising water, a conventional laundry detergent and a laundry detergent additive tablet and subsequently contacting said fabrics with said aqueous bath, wherein said laundry detergent additive tablet comprises an ion exchange resin. A disintegration benefit is provided to the tablet used in the process according to the present invnetion.

### FIELD OF THE INVENTION

This invention relates to a laundry detergent additive tablet and in particular to a process of treating fabrics with a laundry detergent additive tablet having improved disintegration capabilities.

### BACKGROUND OF THE INVENTION

It is known to provide laundry detergent additives in the form of tablets made by compacting a particulate detergent composition.

Although it is necessary that these laundry detergent additive tablets have a good integrity before use, it is also necessary that they disintegrate rapidly during use, this means, when contacted with water during the wash.

It is well known in the art to include a disintegrant, which will promote disintegration of the tablet in laundry detergent tablets and laundry detergent additive tablets. Various classes of disintegrants are known, including the class in which disintegration is caused by the swelling of the disintegrant. Various swelling disintegrants have been proposed in the literature, for instance in WO 98/54283, with the preference being directed predominantly towards starches, celluloses and water soluble organic polymers. Furthermore, inorganic swelling disintegrants such as bentonite clay have also been mentioned, for instance in EP-A-0 466 484.

Laundry detergent additive tablets comprising the above described disintegrants show an improved disintegration when contacted with water compared to the disintegration of such a tablet not comprising a disintegrant.

However, it is well known that the disintegration performance of such laundry detergent additive tablets may still be further improved.

It is thus an objective of the present invention to provide a laundry detergent additive tablet that delivers disintegration performance benefits.

It has now been found that the above objective can be met by a process of treating a fabric with a laundry detergent additive tablet comprising an ion exchange resin.

The use of ion exchange resins in pharmaceutical tablets is known. For example, EP-A-O 225 615 and WO 98/16237 describe pharmaceutical tablets comprising an ion exchange resin and cellulose.

An advantage of the process as described herein is that the laundry detergent additive tablets herein show integrity before use and disintegrate rapidly during use, meaning when contacted with water, for example, in a washing machine.

### SUMMARY OF THE INVENTION

The present invention encompasses a process of treating fabrics which comprises the steps of forming an aqueous bath comprising water, a conventional laundry detergent and a laundry detergent additive tablet and subsequently contacting said fabrics with said aqueous bath, wherein said laundry detergent additive tablet comprises an ion exchange resin.

In a preferred embodiment of the present invention, the tablet herein additionally comprises a further disintegrant, preferably a water-swelling cellulose.

In still another preferred embodiment of the present invention, the tablet herein is a bleach additive tablet, and therefore additionally comprises a bleaching agent.

### DETAILED DESCRIPTION OF THE INVENTION

Process of Treating Fabrics

The tablets herein are laundry detergent additive tablets. By “laundry detergent additive tablet” it is meant herein that the tablets of the present invention are used in conjunction with a conventional laundry detergent composition.

The process of treating fabrics herein comprises the steps of forming an aqueous bath comprising water, a conventional laundry detergent and a laundry detergent additive tablet, as described herein, subsequently contacting said fabrics with said aqueous bath.

In a preferred embodiment according to the present invention, the conventional laundry detergent as described herein and/or, preferably and, the laundry detergent additive tablet as described herein are dissolved or dispersed, preferably substantially dissolved or dispersed, in the aqueous bath formed in the process according to the present invention. By “substantially dissolved or dispersed” it is meant herein, that at least 50%, preferably at least 80%, more preferably at least 90%, even more preferably at least 95%, still more preferably at least 98%, and most preferably at least 99%, of said conventional laundry detergent and/or said laundry detergent additive tablet are dissolved or dispersed in the aqueous bath formed in the process according to the present invention.

The laundry detergent additive tablet and the conventional detergent composition may be delivered into the washing machine either by charging the dispenser drawer of the washing machine with one or both of the detergents or by directly charging the drum of the washing machine with one or both of the detergents. More preferably the laundry detergent additive tablet is directly placed into the drum of the washing machine. Even more preferably the laundry detergent additive tablet and the conventional detergent composition are both placed into the drum of the washing machine. The laundry detergent additive tablet may be delivered to the main wash cycle of the washing machine before, but more preferably at the same time as the conventional detergent composition.

By “conventional laundry detergent” it is meant herein, a laundry detergent composition currently available on the market. Preferably, said conventional laundry detergent comprises at least one surfactant. Said laundry detergent compositions may be formulated as powders, liquids or tablets. Suitable laundry detergent compositions are for example DASH futur®, DASH liquid®, ARIEL tablets® and other products sold under the trade names ARIEL® or TIDE®.

An advantage of this particular embodiment is the cleaning performance. In fact, the cleaning performance benefits of the combination of both the laundry detergent additive tablet and the conventional laundry detergent is greater than the performance provided by either composition alone.

Tablet

Generally, the tablet according to the present invention has a concentration of ion exchange resin of greater than 0.1% by weight of the tablet, preferably greater than 1.0%, and most preferably greater than 1.5% by weight of the tablet. Generally, the upper limit of ion exchange resin content is 10%, more preferably 5%, and most preferably 3% by weight of the tablet.

The tablet may be of uniform composition. Alternatively, the tablet may comprise one or more first regions and one or more second regions (multi-phase tablets or multi-layer tablets), and the concentration of ion exchange resin or other component in the or each first region may be different from the concentration in the or each second region. Preferably the concentration of ion exchange resin in the or each first region is higher than in the or each second region. Thus, it may be at least 1.5 times, or as much as 2 to 5 times the concentration of ion exchange resin in the or each second region. The first region will preferably have a concentration of at least 0.5%, preferably at least 1.0%, ion exchange resin by weight of the or each first region. More than 50% of the total ion exchange resin content of the tablet may be in the or each first region, preferably at least 60%, and more preferably at least 70% by weight of the tablet.

In a preferred embodiment of the present invention, said first region or regions comprise 100% of the total ion exchange resin present in the tablet and said second region or regions are substantially free of ion exchange resin. In another preferred embodiment of the present invention, said first region or regions are substantially free of ion exchange resin and said second region or regions comprise 100% of the total ion exchange resin present in the tablet.

The discrete first and second regions may be domains or other zones within the tablet, for instance created by forming the tablet from a particulate mixture containing large granules, typically above 1 mm, wherein some or all of the large granules have one content and the remainder of the large granules or the remainder of the particulate mixture have a different content, thereby forming the first and second regions in the compressed tablet. Preferably, however, the tablet is a multi-layer tablet and each region is a layer. If there are three layers, the tablet is typically a sandwich having similar layers on each outer surface and a different central layer.

In another preferred embodiment of the present invention, the tablets according to the present invention are multi-phase tablets, preferably multi-phase tablets having two separate phases. Multi-phase tablets are described in the Applicant's patent application PCT/US99/15492 (attorney's docket number CM1 805M5).

Different layers or phases of the tablet may be coloured.

Typically the first regions make up from 5% to 95%, preferably from 10% to 90% with the second regions containing the remainder.

Preferably the ion exchange resin is incorporated into the tablet in the form, of a fine powder. Including the ion exchange resin as fine powder instead of granules may increase the disintegration effect of the ion exchange resin.

The tablets of the invention are of a size that is convenient for dosing in a washing machine. The preferred size is from 3 g to 45 g, preferably from 5 g to 35 g, and the size can be selected in accordance with the intended wash load and the design of the washing machine which is to be used.

In a highly preferred embodiment of the present invention the tablet may additionally comprise a bleaching agent. If the ion exchange resin is more highly concentrated in one or more first regions than second regions, the concentration of said bleaching agent is preferably higher in the first regions than the second regions. Preferably the concentration of the bleaching agent in the or each first region is at least 1.5 times the concentration in the or each second region and preferably substantially all the bleaching agent is in the or each first region.

The tablet may further comprise an enzyme.

The tablet may further comprise a laundry detergent, preferably the tablet further comprises at least 0.5% by weight of the tablet of laundry detergents, more preferably including non-ionic and/or anionic surfactants. If desired, the surfactant also may be present in a higher concentration in some regions than other regions (e.g., at least 1.5 times and usually 2-5 times).

Ion Exchange Resin

As an essential ingredient the tablets herein comprise an ion exchange resin. Any ion exchange resin known to those skilled in the art capable of exchanging ions, preferably ions in aqueous solution, can be used in the tablets according to the present invention.

Suitable ion exchange resins herein are either weak or strong, anion or cation exchange resins.

By “weak ion exchange resin” it is meant herein, a resin which has weak acid or base functional groups attached to the polymeric matrix. A weak acid group is characterized in that its pKₐ is higher than 2.5. A weak base is characterized in that its pK_{b} is higher than 2.5.

By “strong ion exchange resin” it is meant herein, a resin which has strong acid or base functional groups attached to the polymeric matrix. A strong acid group is characterized in that its pKₐ is lower than 2.5. A strong base is characterized in that its pK_{b} is lower than 2.5.

Suitable weak anion exchange resins herein are selected from the group consisting of resins having primary, secondary or tertiary amines as the functional group and mixtures thereof. A preferred weak anion exchange resin is a phenolic-based polyamine condensate.

Suitable strong anion exchange resins herein are selected from the group consisting of resins having quaternary ammonium groups as the functional exchange sites and mixtures thereof.

Suitable weak cation exchange resins herein are selected from the group consisting of resins having carboxylic acid groups as the functional groups and mixtures thereof. A preferred weak cation exchange resin is a copolymer of methacrylic acid and divinylbenzene in the form of its potassium salt, commercially available under the trade name of Amberlite IRP-88® from Polyscience Inc.

Suitable strong cation exchange resins herein are selected from the group consisting of resins having sulphonic acid groups as the functional groups and mixtures thereof.

Furthermore, the ion exchange resin may be either crosslinked or non-crosslinked.

Preferably, the ion exchange resins herein are water-insoluble, water-swellable polymers.

In a preferred embodiment according to the present invention, the ion exchange resin is a cation exchange resin. More preferably, the ion exchange resin is a strong cation exchange resin. Even more preferably, said cation exchange resin is selected from the group consisting of sulfonated polystyrene resins and acrylic or methacrylic resins and mixtures thereof. Most preferably, the ion exchange resin herein is a crosslinked polystyrene sulphonate resin.

Suitable crosslinked polystyrene sulphonate resins are commercially available under the trade name PG2000-Na® from Purolite.

The present invention is based on the surprising finding that the use of an ion exchange resin in a detergent tablet, provides disintegration benefits. Indeed, it has been observed that the disintegration rate of the tablet increases when adding an ion exchange resin (“disintegration benefit”). It is believed that the increase in the disintegration rate is due to the fact that the resin has, due to its ion exchange properties, a high water uptake capacity which helps water to penetrate the inner part of the tablet. Upon water uptake, the resin swells, and thus increases its volume, which in turn breaks the tablet and facilitates the tablet disintegration in water.

Disintegration Test Method

Tablet disintegration performance can be assessed using the following test method:

The tablet is suspended in three liters of cold water within a net or a cage having openings of approx. 3 mm width. The time from immersion of the tablet into the water until no pieces of the tablets remain within the net or the cage (complete disintegration) is measured. The test is repeated a sufficient, number of times to ensure good reproducibility, preferably at least 3 times.

Disintegration Agent

As an optional but highly preferred optional ingredient, the tablets herein comprise a further disintegration agent in addition to the ion exchange resin.

Suitable disintegration agents include agents that swell on contact with water or facilitate water influx and/or efflux by forming channels in the detergent tablet. Any known disintegrating suitable for use in laundry applications are envisaged for use herein. Suitable disintegration agents are selected from the group consisting of : starches such as: natural, modified or pre-gelatinised starch and sodium starch gluconate; starch derivatives such as cellulose and derivatives thereof; gums: agar gum, guar gum, locust bean gum, karaya gum, pectin gum, tragacanth gum; algenic acid and its salts including sodium alginate; silicone dioxide; soy polysaccharides; polyvinylpyrrolidone; crospovidone; clays; acetate trihydrate; burkeite; monohydrated carbonate formula Na₂CO₃.H₂O; hydrated STPP with a phase I content of at least about 40%; carboxymethylcellulose (CMC); CMC-based polymers; sodium acetate; aluminium oxide; and mixtures thereof.

Preferred further disintegration agents herein are selected from the group consisting of: celluloses and derivatives thereof; microcrystalline cellulose; and mixtures thereof.

Suitable cellulose is commercially available under the tradename Arbocel®, commercially available from Rettenmaier and Nymcel® available from Metsa-serla. Suitable microcrystalline cellulose is available under the tradename Vivapur® from Rettenmaier.

The tablets according to the present invention comprise from 0.5% to 15%, preferably from 1% to 10%, more preferably from 2% to 5% by weight of the tablet of a further disintegration agent.

It has been found that the further disintegration agent, preferably cellulose, derivatives thereof and/or microcrystalline cellulose, when present, not only further improves the disintegration performance of the tablet herein but also provides good tablet integrity.

By “tablet integrity” it is meant herein, the tablet strength prior to the use of the tablet. A high tablet strength prevents the tablet from breaking up during manufacture and/or storage.

The applicant has surprisingly found that the further disintegration agent allows to maintain the excellent disintegrating rate provided by the ion exchange resin while maintaining good tablet integrity. This is achieved thanks to the binding capacity of the further disintegrant which compensates the loss of compressibility consequent to the addition of the ion exchange resin to the tablet.

Tablet Integrity Test Method

Tablet integrity can be assessed measuring the Child Bite Strength (CBS) defined as the applied strength at which fracture of the tablet occurs. CBS can be suitably measured by the use of a compression tester such as CT5® from Holland Limited (Nottingham, England) equipped with suitable jaws to fit the tablet.

Bleaching Agent

A highly preferred component of the laundry detergent tablets as described herein is a bleaching agent. Suitable bleaching agents include chlorine and oxygen-releasing bleaching agents.

Indeed, the highly preferred but optional presence of a bleaching agent in the tablets as described herein provides excellent bleaching performance to the laundry detergent additive tablets herein. In the preferred embodiment wherein the laundry detergent additive tablets additionally comprise a bleaching agent, the tablets are used as bleaching laundry detergent additive tablets.

The bleaching performance may be evaluated by the following test methods on various types of stains.

A suitable test method for evaluating the bleaching performance on a soiled fabric is the following: A laundry detergent additive tablets additionally comprising a bleaching agent according to the present invention is added into a standard washing machine in combination with a conventional laundry detergent (e.g., DASH futur® or DASH liquid®). A stained fabric (e.g., a fabric stained with bleachable stains like coffee, tea and the like) is treated in said washing machine according to the standard procedure of the washing machine. After the treatment said fabric is compared to a similarly stained fabric treated as described above but with a laundry detergent additive tablet comprising no bleaching agent.

A visual grading may be used to assign difference in panel units (psu) in a range from 0 to 4, wherein 0 means no noticeable difference in bleaching performance between a tablet additionally comprising a bleaching agent and a tablet as described herein comprising no bleaching agent and 4 means a noticeable difference in bleaching performance between a tablet additionally comprising a bleaching agent and a tablet as described herein comprising no bleaching agent.

In one preferred embodiment herein, wherein the bleaching agent (when present) is an oxygen-releasing bleaching agent, said oxygen-releasing bleaching agent contains a hydrogen peroxide source and an organic peroxyacid bleach precursor compound. The production of the organic peroxyacid occurs by an in situ reaction of the precursor with a source of hydrogen peroxide. Preferred sources of hydrogen peroxide include inorganic perhydrate bleaches. In an alternative preferred aspect a preformed organic peroxyacid is incorporated directly into the composition. Compositions containing mixtures of a hydrogen peroxide source and organic peroxyacid precursor in combination with a preformed organic peroxyacid are also envisaged.

Inorganic Perhydrate Bleaches

The detergent tablets as described herein preferably include a hydrogen peroxide source, as an oxygen-releasing bleach. Suitable hydrogen peroxide sources include the inorganic perhydrate salts.

The inorganic perhydrate salts are normally incorporated in the form of the sodium salt at a level of from 1% to 40% by weight, more preferably from 2% to 30% by weight and most preferably from 5% to 25% by weight of the tablets.

Examples of inorganic perhydrate salts include perborate, percarbonate, perphosphate, persulfate and persilicate salts. The inorganic perhydrate salts are normally the alkali metal salts. The inorganic perhydrate salt may be included as the crystalline solid without additional protection. For certain perhydrate salts however, the preferred executions of such granular compositions utilize a coated form of the material which provides better storage stability for the perhydrate salt in the granular product.

Sodium perborate can be in the form of the monohydrate of nominal formula NaBO₂H₂O₂ or the tetrahydrate NaBO₂H₂O₂.3H₂O.

Alkali metal percarbonates, particularly sodium percarbonate, are preferred perhydrates for inclusion in compositions in accordance with the invention. Sodium percarbonate is an addition compound having a formula corresponding to 2Na₂CO₃.3H₂O₂, and is available commercially as a crystalline solid. Sodium percarbonate, being a hydrogen peroxide addition compound tends on dissolution to release the hydrogen peroxide quite rapidly which can increase the tendency for localised high bleach concentrations to arise. The percarbonate is most preferably incorporated into such compositions in a coated form which provides in-product stability.

A suitable coating material providing in product stability comprises mixed salt of a water soluble alkali metal sulphate and carbonate. Such coatings together with coating processes have previously been described in GB-1,466,799, granted to Interox on 9th March 1977. The weight ratio of the mixed salt coating material to percarbonate lies in the range from 1:200 to 1:4, more preferably from 1:99 to 1:9, and most preferably from 1:49 to 1:19. Preferably, the mixed salt is of sodium sulphate and sodium carbonate which has the general formula Na₂SO₄.n.Na₂CO₃ wherein n is from 0.1 to 3, preferably n is from 0.3 to 1.0 and most preferably n is from 0.2 to 0.5.

Another suitable coating material providing in product stability, comprises sodium silicate of SiO₂:Na₂O ratio from 1.8:1 to 3.0:1, preferably 1.8:1 to 2.4:1, and/or sodium metasilicate, preferably applied at a level of from 2% to 10%, (normally from 3% to 5%) of SiO₂ by weight of the inorganic perhydrate salt. Magnesium silicate can also be included in the coating. Coatings that contain silicate and borate salts or boric acids or other inorganics are also suitable.

Other coatings which contain waxes, oils, fatty soaps can also be used advantageously within the present invention.

Potassium peroxymonopersulfate is another inorganic perhydrate salt of utility in the compositions herein.

Peroxyacid Bleach Precursor

Peroxyacid bleach precursors are compounds which react with hydrogen peroxide in a perhydrolysis reaction to produce a peroxyacid. Generally peroxyacid bleach precursors may be represented as

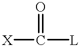

where L is a leaving group and X is essentially any functionality, such that on perhydrolysis the structure of the peroxyacid produced is

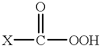

Peroxyacid bleach precursor compounds are preferably incorporated at a level of from 0.5% to 20% by weight, more preferably from 1% to 10% by weight, most preferably from 1.5% to 5% by weight of the tablets.

Suitable peroxyacid bleach precursor compounds typically contain one or more N- or O-acyl groups, which precursors can be selected from a wide range of classes. Suitable classes include anhydrides, esters, imides, lactams and acylated derivatives of imidazoles and oximes. Examples of useful materials within these classes are disclosed in GB-A-1586789. Suitable esters are disclosed in GB-A-836988, 864798,1147871, 2143231 and EP-A-0170386.

Leaving Groups

The leaving group, hereinafter L group, must be sufficiently reactive for the perhydrolysis reaction to occur within the optimum time frame (e.g., a wash cycle). However, if L is too reactive, this activator will be difficult to stabilise for use in a bleaching composition.

Preferred L groups are selected from the group consisting of:

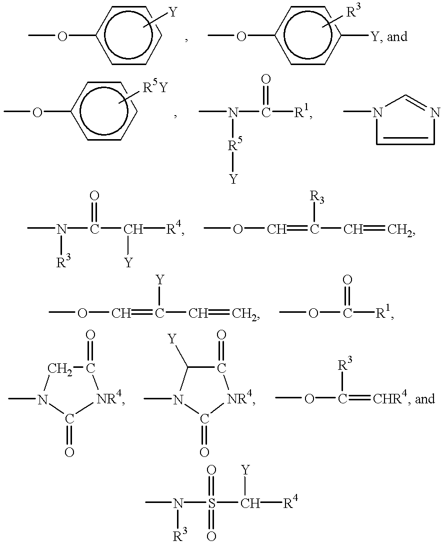

and mixtures thereof, wherein R¹ is an alkyl, aryl, or alkaryl group containing from 1 to 14 carbon atoms, R³ is an alkyl chain containing from 1 to 8 carbon atoms, R⁴ is H or R³, R⁵ is an alkenyl chain containing from 1 to 8 carbon atoms and Y is H or a solubilizing group. Any of R¹, R³ and R⁴ may be substituted by essentially any functional group including, for example alkyl, hydroxy, alkoxy, halogen, amine, nitrosyl, amide and ammonium or alkyl ammonium groups.

The preferred solubilizing groups are —SO₃⁻M⁺, —CO₂⁻M⁺, —SO₄⁻M⁺, —N⁺ (R³)₄X⁻ and O←N(R³)₃ and most preferably —SO₃⁻M⁺ and —CO₂⁻M⁺ wherein R³ is an alkyl chain containing from 1 to 4 carbon atoms, M is a cation which provides solubility to the bleach activator and X is an anion which provides solubility to the bleach activator. Preferably, M is an alkali metal, ammonium or substituted ammonium cation, with sodium and potassium being most preferred, and X is a halide, hydroxide, methylsulfate or acetate anion.

Perbenzoic Acid Precursor

Perbenzoic acid precursor compounds provide perbenzoic acid on perhydrolysis.

Suitable O-acylated perbenzoic acid precursor compounds include the substituted and unsubstituted benzoyl oxybenzene sulfonates, including for example benzoyl oxybenzene sulfonate:

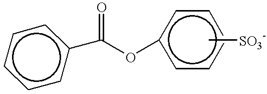

Also suitable are the benzoylation products of sorbitol, glucose, and all saccharides with benzoylating agents, including for example:

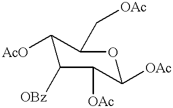

Ac=COCH3; Bz=Benzoyl

Perbenzoic acid precursor compounds of the imide type include N-benzoyl succinimide, tetrabenzoyl ethylene diamine and the N-benzoyl substituted ureas. Suitable imidazole type perbenzoic acid precursors include N-benzoyl imidazole and N-benzoyl benzimidazole and other useful N-acyl group-containing perbenzoic acid precursors include N-benzoyl pyrrolidone, dibenzoyl taurine and benzoyl pyroglutamic acid.

Other perbenzoic acid precursors include the benzoyl diacyl peroxides, the benzoyl tetraacyl peroxides, and the compound having the formula:

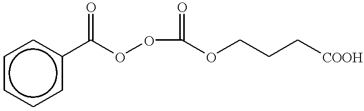

Phthalic anhydride is another suitable perbenzoic acid precursor compound herein:

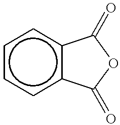

Suitable N-acylated lactam perbenzoic acid precursors have the formula:

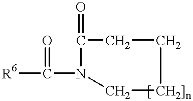

wherein n is from 0 to 8, preferably from 0 to 2, and R⁶ is a benzoyl group.

Perbenzoic Acid Derivative Precursors

Perbenzoic acid derivative precursors provide substituted perbenzoic acids on perhydrolysis.

Suitable substituted perbenzoic acid derivative precursors include any of the herein disclosed perbenzoic precursors in which the benzoyl group is substituted by essentially any non-positively charged (i.e.; non-cationic) functional group including, for example alkyl, hydroxy, alkoxy, halogen, amine, nitrosyl and amide groups.

A preferred class of substituted perbenzoic acid precursor compounds are the amide substituted compounds of the following general formulae:

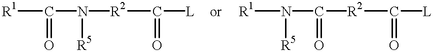

wherein R¹ is an aryl or alkaryl group with from 1 to 14 carbon atoms, R² is an arylene, or alkarylene group containing from 1 to 14 carbon atoms, and R⁵ is H or an alkyl, aryl, or alkaryl group containing 1 to 10 carbon atoms and L can be essentially any leaving group. R¹ preferably contains from 6 to 12 carbon atoms. R² preferably contains from 4 to 8 carbon atoms. R¹ may be aryl, substituted aryl or alkylaryl containing branching, substitution, or both and may be sourced from either synthetic sources or natural sources including for example, tallow fat. Analogous structural variations are permissible for R². The substitution can include alkyl, aryl, halogen, nitrogen, sulphur and other typical substituent groups or organic compounds. R⁵ is preferably H or methyl. R¹ and R⁵ should not contain more than 18 carbon atoms in total. Amide substituted bleach activator compounds of this type are described in EP-A-01 70386.

Cationic Peroxyacid Precursors

Cationic peroxyacid precursor compounds produce cationic peroxyacids on perhydrolysis.

Typically, cationic peroxyacid precursors are formed by substituting the peroxyacid part of a suitable peroxyacid precursor compound with a positively charged functional group, such as an ammonium or alkyl ammonium group, preferably an ethyl or methyl ammonium group. Cationic peroxyacid precursors are typically present in the compositions as a salt with a suitable anion, such as for example a halide ion or a methylsulfate ion.

The peroxyacid precursor compound to be so cationically substituted may be a perbenzoic acid, or substituted derivative thereof, precursor compound as described hereinbefore. Alternatively, the peroxyacid precursor compound may be an alkyl percarboxylic acid precursor compound or an amide substituted alkyl peroxyacid precursor as described hereinafter Cationic peroxyacid precursors are described in U.S. Pat. Nos. 4,904,406; 4,751,015; 4,988,451; 4,397,757; 5,269,962; 5,127,852; 5,093,022; 5,106,528; U.K. 1,382,594; EP 475,512, 458,396 and 284,292; and in JP 87-318,332.

Suitable cationic peroxyacid precursors include any of the ammonium or alkyl ammonium substituted alkyl or benzoyl oxybenzene sulfonates, N-acylated caprolactams, and monobenzoyltetraacetyl glucose benzoyl peroxides.

A preferred cationically substituted benzoyl oxybenzene sulfonate is the 4-(trimethyl ammonium) methyl derivative of benzoyl oxybenzene sulfonate:

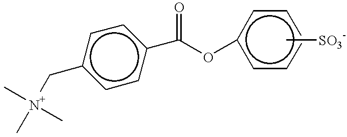

A preferred cationically substituted alkyl oxybenzene sulfonate has the formula:

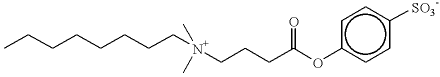

Preferred cationic peroxyacid precursors of the N-acylated caprolactam class include the trialkyl ammonium methylene benzoyl caprolactams, particularly trimethyl ammonium methylene benzoyl caprolactam:

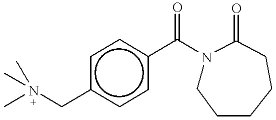

Other preferred cationic peroxyacid precursors of the N-acylated caprolactam class include the trialkyl ammonium methylene alkyl caprolactams:

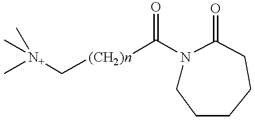

wherein n is from 0 to 12, particularly from 1 to 5.

Another preferred cationic peroxyacid precursor is 2-(N,N,N-trimethyl ammonium) ethyl sodium 4-sulphophenyl carbonate chloride.

Alkyl Percarboxylic Acid Bleach Precursors

Alkyl percarboxylic acid bleach precursors form percarboxylic acids on perhydrolysis. Preferred precursors of this type provide peracetic acid on perhydrolysis.

Preferred alkyl percarboxylic precursor compounds of the imide type include the N-,N,N¹N¹ tetra acetylated alkylene diamines wherein the alkylene group contains from 1 to 6 carbon atoms, particularly those compounds in which the alkylene group contains 1, 2 and 6 carbon atoms. Tetraacetyl ethylene diamine (TAED) is particularly preferred.

Other preferred alkyl percarboxylic acid precursors include sodium 3,5,5-tri-methyl hexanoyloxybenzene sulfonate (iso-NOBS), sodium nonanoyloxybenzene sulfonate (NOBS), sodium acetoxybenzene sulfonate (ABS) and penta acetyl glucose.

Amide Substituted Alkyl Peroxyacid Precursors

Amide substituted alkyl peroxyacid precursor compounds are also suitable, including those of the following general formulae:

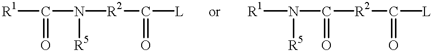

wherein R¹ is an alkyl group with from 1 to 14 carbon atoms, R² is an alkylene group containing from 1 to 14 carbon atoms, and R⁵ is H or an alkyl group containing 1 to 10 carbon atoms and L can be essentially any leaving group. R¹ preferably contains from 6 to 12 carbon atoms. R² preferably contains from 4 to 8 carbon atoms. R¹ may be straight chain or branched alkyl containing branching, substitution, or both and may be sourced from either synthetic sources or natural sources including for example, tallow fat. Analogous structural variations are permissible for R². The substitution can include alkyl, halogen, nitrogen, sulphur and other typical substituent groups or organic compounds. R⁵ is preferably H or methyl. R¹ and R⁵ should not contain more than 18 carbon atoms in total. Amide substituted bleach activator compounds of this type are described in EP-A-0170386.

Benzoxazin Organic Peroxyacid Precursors

Also suitable are precursor compounds of the benzoxazin-type, as disclosed for example in EP-A-332,294 and EP-A-482,807, particularly those having the formula:

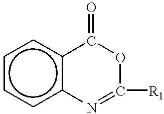

including the substituted benzoxazins of the type

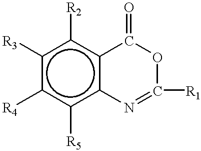

wherein R₁ is H, alkyl, alkaryl, aryl, arylalkyl, and wherein R₂, R₃, R₄, and R₅ may be the same or different substituents selected from H, halogen, alkyl, alkenyl, aryl, hydroxyl, alkoxyl, amino, alkyl amino, COOR₆ (wherein R₆ is H or an alkyl group) and carbonyl functions.

An especially preferred precursor of the benzoxazin-type is:

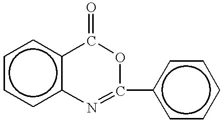

Preformed Organic Peroxyacid

The organic peroxyacid bleaching system may contain, in addition to, or as an alternative to, an organic peroxyacid bleach precursor compound, a preformed organic peroxyacid, typically at a level of from 0.5% to 25% by weight, more preferably from 1% to 10% by weight of the composition.

A preferred class of organic peroxyacid compounds are the amide substituted compounds of the following general formulae:

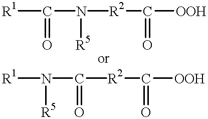

wherein R¹ is an alkyl, aryl or alkaryl group with from 1 to 14 carbon atoms, R² is an alkylene, arylene, and alkarylene group containing from 1 to 14 carbon atoms, and R⁵ is H or an alkyl, aryl, or alkaryl group containing 1 to 10 carbon atoms. R¹ preferably contains from 6 to 12 carbon atoms. R² preferably contains from 4 to 8 carbon atoms. R¹ may be straight chain or branched alkyl, substituted aryl or alkylaryl containing branching, substitution, or both and may be sourced from either synthetic sources or natural sources including for example, tallow fat. Analogous structural variations are permissible for R². The substitution can include alkyl, aryl, halogen, nitrogen, sulphur and other typical substituent groups or organic compounds. R⁵ is preferably H or methyl. R¹ and R⁵ should not contain more than 18 carbon atoms in total. Amide substituted organic peroxyacid compounds of this type are described in EP-A-0170386.

Other organic peroxyacids include diacyl and tetraacylperoxides, especially diperoxydodecanedioc acid, diperoxytetradecanedioc acid, and diperoxyhexadecanedioc acid. Dibenzoyl peroxide is a preferred organic peroxyacid herein. Mono- and diperazelaic acid, mono- and diperbrassylic acid, and N-phthaloylaminoperoxicaproic acid are also suitable herein.

Metal-containing Bleach Catalyst

The tablet described herein which contain bleach as an optional component may additionally contain as a preferred component, a metal containing bleach catalyst. Preferably the metal containing bleach catalyst is a transition metal containing bleach catalyst, more preferably a manganese or cobalt-containing bleach catalyst.

The tablets of the present invention may comprise an effective amount of a bleach catalyst. The term “an effective amount” is defined as “an amount of the transition-metal bleach catalyst present in the present invention compositions, or during use according to the present invention methods, that is sufficient, under whatever comparative or use conditions are employed, to result in at least partial oxidation of the material sought to be oxidized by the composition or method.”

Preferably the tablets of the present invention comprise from 1 ppb (0.0000001%), more preferably from 100 ppb (0.00001%), yet more preferably from 500 ppb (0.00005%), still more preferably from 1 ppm (0.0001%) to 99.9%, more preferably to 50%, yet more preferably to 5%, still more preferably to 500 ppm (0.05%) by weight of the composition, of a metal bleach catalyst as described herein below.

A suitable type of bleach catalyst is a catalyst comprising a heavy metal cation of defined bleach catalytic activity, such as copper, iron cations, an auxiliary metal cation having little or no bleach catalytic activity, such as zinc or aluminium cations, and a sequestrant having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

Preferred types of bleach catalysts include the manganese-based complexes disclosed in U.S. Pat. Nos. 5,246,621 and 5,244,594. Preferred examples of these catalysts include Mn^{IV}₂(u-O)₃(1,4,7-trimethyl-1,4,7-triazacyclononane)₂-(PF₆)₂, Mn^{III}₂(u-O)₁(u-OAc)₂(1,4,7-trimethyl-1,4,7-triazacyclononane)₂-(ClO₄)₂, Mn^{IV}₄(u-O)₆(1,4,7-triazacyclononane)₄-(ClO₄)₂, Mn^{III}Mn^{IV}₄(u-O)₁(u-OAc)₂₋(1,4,7-trimethyl-1,4,7-triazacyclononane)₂-(ClO₄)₃, and mixtures thereof. Others are described in European patent application publication no. 549,272. Other ligands suitable for use herein include 1,5,9-trimethyl-1,5,9-triazacyclododecane, 2-methyl-1,4,7-triazacyclononane, 2-methyl-1,4,7-triazacyclononane, 1,2,4,7-tetramethyl-1,4,7-triazacyclononane, and mixtures thereof.

The bleach catalysts useful in the compositions herein may also be selected as appropriate for the present invention. For examples of suitable bleach catalysts see U.S. Pat. Nos. 4,246,612 and 5,227,084. See also U.S. Pat. No. 5,194,416 which teaches mononuclear manganese (IV) complexes such as Mn(1,4,7-trimethyl-1,4,7-triazacyclononane)(OCH₃)3-(PF₆).

Still another type of bleach catalyst, as disclosed in U.S. Pat. No. 5,114,606, is a water-soluble complex of manganese (III), and/or (IV) with a ligand which is a non-carboxylate polyhydroxy compound having at least three consecutive C—OH groups. Preferred ligands include sorbitol, iditol, dulsitol, mannitol, xylithol, arabitol, adonitol, meso-erythritol, meso-inositol, lactose, and mixtures thereof.

U.S. Pat. No. 5,114,611 teaches a bleach catalyst comprising a complex of transition metals, including Mn, Co, Fe, or Cu, with an non-(macro)-cyclic ligand. Said ligands are of the formula:

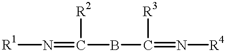

wherein R¹, R², R³, and R⁴ can each be selected from H, substituted alkyl and aryl groups such that each R¹—N═C—R² and R³—C═N—R⁴ form a five or six-membered ring. Said ring can further be substituted. B is a bridging group selected from O, S. CR⁵R⁶, NR⁷ and C═O, wherein R⁵, R⁶, and R⁷ can each be H, alkyl, or aryl groups, including substituted or unsubstituted groups. Preferred ligands include pyridine, pyridazine, pyrimidine, pyrazine, imidazole, pyrazole, and triazole rings. Optionally, said rings may be substituted with substituents such as alkyl, aryl, alkoxy, halide, and nitro. Particularly preferred is the ligand 2,2′-bispyridylamine. Preferred bleach catalysts include Co, Cu, Mn, Fe,-bispyridylmethane and -bispyridylamine complexes. Highly preferred catalysts include Co(2,2′-bispyridylamine)Cl₂, Di(isothiocyanato)bispyridylamine-cobalt (II), trisdipyridylamine-cobalt(II) perchlorate, Co(2,2-bispyridylamine)₂O₂ClO₄, Bis-(2,2′-bispyridylamine) copper(II) perchlorate, tris(di-2-pyridylamine) iron(II) perchlorate, and mixtures thereof.

Preferred examples include binuclear Mn complexes with tetra-N-dentate and bi-N-dentate ligands, including N₄Mn^{III}(u-O)₂Mn^{IV}N₄)⁺ and [Bipy₂Mn^{III}(u-O)₂Mn^{IV}bipy₂]-(ClO₄)₃.

While the structures of the bleach-catalyzing manganese complexes of the present invention have not been elucidated, it may be speculated that they comprise chelates or other hydrated coordination complexes which result from the interaction of the carboxyl and nitrogen atoms of the ligand with the manganese cation. Likewise, the oxidation state of the manganese cation during the catalytic process is not known with certainty, and may be the (+II), (+III), (+IV) or (+V) valence state. Due to the ligands' possible six points of attachment to the manganese cation, it may be reasonably speculated that multi-nuclear species and/or “cage” structures may exist in the aqueous bleaching media. Whatever the form of the active Mn. ligand species which actually exists, it functions in an apparently catalytic manner to provide improved bleaching performances on stubborn stains such as tea, ketchup, coffee, wine, juice, and the like.

Other bleach catalysts are described, for example, in European patent application, publication no. 408,131 (cobalt complex catalysts), European patent applications, publication nos. 384,503, and 306,089 (metallo-porphyrin catalysts), U.S. Pat. No. 4,728,455 (manganese/multidentate ligand catalyst), U.S. Pat. No. 4,711,748 and European patent application, publication no. 224,952, (absorbed manganese on aluminosilicate catalyst), U.S. Pat. No. 4,601,845 (aluminosilicate support with manganese and zinc or magnesium salt), U.S. Pat. No. 4,626,373 (manganese/ligand catalyst), U.S. Pat. No. 4,119,557 (ferric complex catalyst), German Pat. specification 2,054,019 (cobalt chelant catalyst) Canadian 866,191 (transition metal-containing salts), U.S. Pat. No. 4,430,243 (chelants with manganese cations and non-catalytic metal cations), and U.S. Pat. No. 4,728,455 (manganese gluconate catalysts).

Other preferred examples include cobalt (III) catalysts having the formula:

Co[(NH₃)ₙM′ₘB′_{b}T′ₜQ_{q}Pₚ]Y_{y}

wherein cobalt is in the +3 oxidation state; n is an integer from 0 to 5 (preferably 4 or 5; most preferably 5); M′ represents a monodentate ligand; m is an integer from 0 to 5 (preferably 1 or 2; most preferably 1); B′ represents a bidentate ligand; b is an integer from 0 to 2; T′ represents a tridentate ligand; t is 0 or 1; Q is a tetradentate ligand; q is 0 or 1; P is a pentadentate ligand; p is 0 or 1; and n+m+2b+3t+4q+5p=6; Y is one or more appropriately selected counteranions present in a number y, where y is an integer from 1 to 3 (preferably 2 to 3; most preferably 2 when Y is a −1 charged anion), to obtain a charge-balanced salt, preferred Y are selected from the group consisting of chloride, nitrate, nitrite, sulfate, citrate, acetate, carbonate, and combinations thereof; and wherein further at least one of the coordination sites attached to the cobalt is labile under laundry treatment use conditions and the remaining co-ordination sites stabilise the cobalt under laundry treatment conditions such that the reduction potential for cobalt (III) to cobalt (II) under alkaline conditions is less than 0.4 volts (preferably less than 0.2 volts) versus a normal hydrogen electrode.

Preferred cobalt catalysts of this type have the formula:

[Co(NH₃)ₙ(M′)ₘ]Y_{y}

wherein n is an integer from 3 to 5 (preferably 4 or 5; most preferably 5); M′ is a labile coordinating moiety, preferably selected from the group consisting of chlorine, bromine, hydroxide, water, and (when m is greater than 1) combinations thereof; m is an integer from 1 to 3 (preferably 1 or 2; most preferably 1); m+n=6; and Y is an appropriately selected counteranion present in a number y, which is an integer from 1 to 3 (preferably 2 to 3; most preferably 2 when Y is a −1 charged anion), to obtain a charge-balanced salt.

The preferred cobalt catalyst of this type useful herein are cobalt pentaamine chloride salts having the formula [Co(NH₃)₅Cl]Y_{y}, and especially [Co(NH₃)₅Cl]Cl₂.

More preferred are the present invention compositions which utilize cobalt (III) bleach catalysts having the formula:

[Co(NH₃)ₙ(M)ₘ(B)_{b}]T_{y}

wherein cobalt is in the +3 oxidation state; n is 4 or 5 (preferably 5); M is one or more ligands coordinated to the cobalt by one site; m is 0, 1 or 2 (preferably 1); B is a ligand coordinated to the cobalt by two sites; b is 0 or 1 (preferably 0), and when b=0, then m+n=6, and when b=1, then m=0 and n=4; and T is one or more appropriately selected counteranions present in a number y, where y is an integer to obtain a charge-balanced salt (preferably y is 1 to 3; most preferably 2 when T is a −1 charged anion); and wherein further said catalyst has a base hydrolysis rate constant of less than 0.23 M⁻¹ s⁻¹ (25° C.).

Preferred T are selected from the group consisting of chloride, iodide, I₃⁻, formate, nitrate, nitrite, sulfate, sulfite, citrate, acetate, carbonate, bromide, PF₆⁻, BF₄⁻, B(Ph)₄⁻, phosphate, phosphite, silicate, tosylate, methanesulfonate, and combinations thereof. Optionally, T can be protonated if more than one anionic group exists in T, e.g., HPO₄²⁻, HCO₃⁻, H₂PO₄⁻, etc. Further, T may be selected from the group consisting of non-traditional inorganic anions such as anionic surfactants (e.g., linear alkylbenzene sulfonates (LAS), alkyl sulfates (AS), alkylethoxysulfonates (AES), etc.) and/or anionic polymers (e.g., polyacrylates, polymethacrylates, etc.).

The M moieties include, but are not limited to, for example, F⁻, SO₄⁻², NCS⁻, SCN⁻, S₂O₃⁻², NH₃, PO₄³⁻, and carboxylates (which preferably are mono-carboxylates, but more than one carboxylate may be present in the moiety as long as the binding to the cobalt is by only one carboxylate per moiety, in which case the other carboxylate in the M moiety may be protonated or in its salt form). Optionally, M can be protonated if more than one anionic group exists in M (e.g., HPO₄²⁻, HCO₃⁻, H₂PO₄⁻, HOC(O)CH₂C(O)O—, etc.) Preferred M moieties are substituted and unsubstituted C₁-C₃₀ carboxylic acids having the formulas:

RC(O)O—

wherein R is preferably selected from the group consisting of hydrogen and C₁-C₃₀ (preferably C₁-C₁₈) unsubstituted and substituted alkyl, C₆-C₃₀ (preferably C₆-C₁₈) unsubstituted and substituted aryl, and C₃-C₃₀ (preferably C₅-C₁₈) unsubstituted and substituted heteroaryl, wherein substituents are selected from the group consisting of —NR′₃, —NR′₄⁺, —C(O)OR′, —OR′, —C(O)NR′₂, wherein R′ is selected from the group consisting of hydrogen and C₁-C₆ moieties. Such substituted R therefore include the moieties —(CH₂)ₙOH and —(CH₂)ₙNR′₄⁺, wherein n is an integer from 1 to 16, preferably from 2 to 10, and most preferably from 2 to 5.

Most preferred M are carboxylic acids having the formula above wherein R is selected from the group consisting of hydrogen, methyl, ethyl, propyl, straight or branched C₄-C₁₂ alkyl, and benzyl. Most preferred R is methyl. Preferred carboxylic acid M moieties include formic, benzoic, octanoic, nonanoic, decanoic, dodecanoic, malonic, maleic, succinic, adipic, phthalic, 2-ethylhexanoic, naphthenoic, oleic, palmitic, triflate, tartrate, stearic, butyric, citric, acrylic, aspartic, fumaric, lauric, linoleic, lactic, malic, and especially acetic acid.

The B moieties include carbonate, di- and higher carboxylates (e.g., oxalate, malonate, malic, succinate, maleate), picolinic acid, and alpha and beta amino acids (e.g., glycine, alanine, beta-alanine, phenylalanine).

Cobalt bleach catalysts useful herein are known, being described for example along with their base hydrolysis rates, in M. L. Tobe, “Base Hydrolysis of Transition-Metal Complexes”, Adv. Inorg. Bioinorg. Mech., (1983), 2, pages 1-94. For example, Table 1 at page 17, provides the base hydrolysis rates (designated therein as k_{OH}) for cobalt pentaamine catalysts complexed with oxalate (k_{OH}=2.5×10⁻⁴ M⁻¹ s⁻¹ (25° C.)), NCS⁻ (k_{OH}=5.0×10⁻⁴ M⁻¹ s⁻¹ (25° C.)), formate (k_{OH}=5.8×10⁻⁴ M⁻¹ s⁻¹ (25° C.)), and acetate (k_{OH}=9.6×10⁻⁴ M⁻¹ s⁻¹ (25° C.)). The most preferred cobalt catalyst useful herein are cobalt pentaamine acetate salts having the formula [Co(NH₃)₅OAc]T_{y}, wherein OAc represents an acetate moiety, and especially cobalt pentaamine acetate chloride, [Co(NH₃)₅OAc]Cl₂; as well as [Co(NH₃)₅OAc](OAc)₂; [Co(NH₃)₅OAc](PF₆)₂; [Co(NH₃)₅OAc](SO₄); [Co(NH₃)₅OAc](BF₄)₂; and [Co(NH₃)₅OAc](NO₃)₂ (herein “PAC”).

These cobalt catalysts are readily prepared by known procedures, such as taught for example in the Tobe article hereinbefore and the references cited therein, in U.S. Pat. No. 4,810,410, to Diakun et al., issued Mar. 7, 1989, J. Chem. Ed. (1989), 66 (12), 1043-45; The Synthesis and Characterization of Inorganic Compounds, W. L. Jolly (Prentice-Hall; 1970), pp. 461-3; Inorg. Chem., 18, 1497-1502 (1979); Inorg. Chem., 21, 2881-2885 (1982); Inorg. Chem., 18, 2023-2025 (1979); Inorg. Synthesis, 173-176 (1960); and Journal of Physical Chemistry, 56, 22-25 (1952); as well as the synthesis examples provided hereinafter.

Cobalt catalysts suitable for incorporation into the detergent tablets of the present invention may be produced according to the synthetic routes disclosed in U.S. Pat. Nos. 5,559,261, 5,581,005, and 5,597,936, the disclosures of which are herein incorporated by reference. Other suitable bleach catalysts include transition-metal bleach catalyst comprising:

i) a transition metal selected from the group consisting of Mn(II), Mn(III), Mn(IV), Mn(V), Fe(II), Fe(III), Fe(IV), Co(I), Co(II), Co(III), Ni(I), Ni(II), Ni(III), Cu(I), Cu(II), Cu(III), Cr(II), Cr(III), Cr(IV), Cr(V), Cr(VI), V(III), V(IV), V(V), Mo(IV), Mo(V), Mo(VI), W(IV), W(V), W(VI), Pd(II), Ru(II), Ru(III), and Ru(IV), preferably Mn(II), Mn(III), Mn(IV), Fe(II), Fe(III), Fe(IV), Cr(II), Cr(III), Cr(IV), Cr(V), Cr(VI), and mixtures thereof;

ii) a cross-bridged macropolycyclic ligand being coordinated by four or five donor atoms to the same transition metal, said ligand comprising:

a) an organic macrocycle ring containing four or more donor atoms (preferably at least 3, more preferably at least 4, of these donor atoms are N) separated from each other by covalent linkages of 2 or 3 non-donor atoms, two to five (preferably three to four, more preferably four) of these donor atoms being coordinated to the same transition metal atom in the complex;

b) a cross-bridged chain which covalently connects at least 2 non-adjacent donor atoms of the organic macrocycle ring, said covalently connected non-adjacent donor atoms being bridgehead donor atoms which are coordinated to the same transition metal in the complex, and wherein said cross-bridged chain comprises from 2 to about 10 atoms (preferably the cross-bridged chain is selected from 2, 3 or 4 non-donor atoms, and 4-6 non-donor atoms with a further donor atom); and

iii) optionally, one or more non-macropolycyclic ligands, preferably selected from the group consisting of H₂O, ROH, NR₃, RCN, OH⁻, OOH⁻, RS⁻, RO⁻, RCOO⁻, OCN⁻, SCN⁻, N₃⁻, CN⁻, F^{b-}, Cl⁻, Br⁻, I⁻, O₂⁻, NO₃⁻, NO₂⁻, SO₄²⁻, SO₃²⁻, PO₄³⁻, organic phosphates, organic phosphonates, organic sulfates, organic sulfonates, and aromatic N donors such as pyridines, pyrazines, pyrazoles, imidazoles, benzimidazoles, pyrimidines, triazoles and thiazoles with R being H, optionally substituted alkyl, optionally substituted aryl.

The preferred cross-bridged macropolycyclic ligands are is selected from the group consisting of:

a) a cross-bridged macropolycyclic ligand of formula (I) having denticity of 4 or 5:

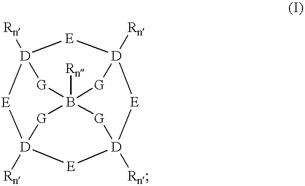

b) a cross-bridged macropolycyclic ligand of formula (II) having denticity of 5 or 6:

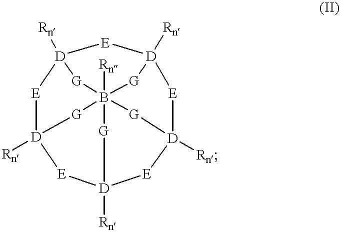

c) the cross-bridged macropolycyclic ligand of formula (III) having denticity of 6 or 7:

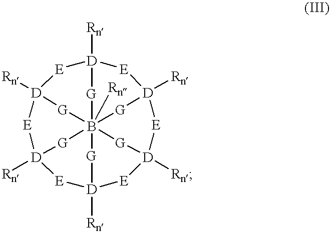

wherein each E unit represents the moiety having the formula:

(CRₙ)ₐ—X—(CRₙ)_{a′}

wherein X is selected from the group consisting of oxygen, sulfur, —NR—, phosphorous, or X represents a covalent bond wherein E has the formula:

(CRₙ)ₐ—(CRₙ)_{a′}

for each E units the sum of a+a′ is independently selected from 1 to 5; each G unit is a moiety (CRₙ)_{b}; each R unit is independently selected from H, alkyl, alkenyl, alkynyl, aryl, alkylaryl, and heteroaryl, or two or more R units are covalently bonded to form an aromatic, heteroaromatic, cycloalkyl, or heterocycloalkyl ring; each D unit is a donor atom independently selected from the group consisting of nitrogen, oxygen, sulfur, and phosphorous, and at least two atoms which comprise D units are bridgehead donor atoms coordinated to the transition metal; B units are a carbon atom, a D unit, or a cycloalkyl or heterocyclic ring; each n is an integer independently selected from 1 and 2, completing the valence of the carbon atoms to which the R units are covalently bonded; each n′ is an integer independently selected from 0 and 1, completing the valence of the D donor atoms to which the R moieties are covalently bonded; each n″ is an integer independently selected from 0, 1, and 2 completing the valence of the B atoms to which the R moieties are covalently bonded; each a and a′ is an integer independently selected from 0 to 5, wherein the sum of all a+a′ values in the ligand of formula (I) is within the range of from about 8 to about 12; the sum of all a+a′ values in the ligand of formula (II) is within the range of from about 10 to about 15; and the sum of all a+a′ values in the ligand of formula (III) is within the range of from about 12 to about 18; each b is an integer independently selected from 0 to 9, or in any of the above formulas, one or more of the (CRn)b moieties covalently bonded from any D to the B atom is absent as long as at least two (CRₙ)_{b} covalently bond two of the D donor atoms to the B atom in the formula, and the sum of all b indices is within the range of from about 2 to about 5.

A further description of the bleach catalysts of the present invention can be found in WO 98/39406 A1, published Sep. 11, 1998, WO 98/39098 A1, published Sep. 11, 1998, and WO 98/39335 A1, published Sep. 11, 1998, all of which are included herein by reference.

The nomenclature herein to describe the transition-metal bleach catalysts is the same nomenclature style used in the above-identified references. However, the chemical names of one or more of the herein described ligands may vary from the chemical name assigned under the rules of the International Union of Pure and Applied Chemistry (IUPAC). For example, a preferred ligand for the purposes of the present invention, 5,12-dimethyl-1,5,8,12-tetraaza-bicyclo[6.6.2]hexadecane, has the IUPAC name 4,1 1-dimethyl-1,4,8,1 1-tetraaza-bicyclo[6.6.2]hexadecane. A further preferred ligand is 5,12-diethyl-1,5,8,12-tetraaza-bicyclo[6.6.2]hexadecane.

Metal bleach catalysts useful in the invention tablets can in general include known compounds where they conform with the invention definition, as well as, more preferably, any of a large number of novel compounds expressly designed for the present laundry use. Suitable bleach catalysts for use in the tablets herein further include for example:

Dichloro-5,12-dimethyl-1,5,8,1 2-tetraazabicyclo[6.6.2]hexadecane Manganese(II);

Dichloro-4,10-dimethyl-1,4,7,10-tetraazabicyclo[5.5.2]tetradecane Manganese(II);

Diaquo-5,12-dimethyl-1,5,8,12-tetraazabicyclo[6.6.2]hexadecane Manganese(II) Hexafluorophosphate;

Aquo-hydroxy-5,12-dimethyl-1,5,8,12-tetraazabicyclo[6.6.2]hexadecane Manganese(III) Hexafluorophosphate;

Diaquo-4,10-dimethyl-1,4,7,10-tetraazabicyclo[5.5.2]tetradecane Manganese(II) Hexafluorophosphate;

Diaquo-5,12-dimethyl-1,5,8,12-tetraazabicyclo[6.6.2]hexadecane Manganese(II) Tetrafluoroborate;

Diaquo-4,10-dimethyl-1,4,7,10-tetraazabicyclo[5.5.2]tetradecane Manganese(II) Tetrafluoroborate;

Dichloro-5,12-dimethyl-1,5,8,12-tetraazabicyclo[6.6.2]hexadecane Manganese(III) Hexafluorophosphate;

Dichloro-5,12-di-n-butyl-1,5,8,12-tetraaza-bicyclo[6.6.2]hexadecane Manganese(II);

Dichloro-5,12-dibenzyl-1,5,8,12-tetraazabicyclo[6.6.2]hexadecane Manganese(II);

Dichloro-5-n-butyl-12-methyl-1,5,8,12-tetraaza-bicyclo[6.6.2]hexadecane Manganese(II);

Dichloro-5-n-octyl-12-methyl-1,5,8,1 2-tetraaza-bicyclo[6.6.2]hexadecane Manganese(II);

Dichloro-5-n-butyl-12-methyl-1,5,8,12-tetraaza-bicyclo[6.6.2]hexadecane Manganese(II);

Dichloro-5,12-dimethyl-1,5,8,12-tetraazabicyclo[6.6.2]hexadecane Iron(II);

Dichloro-4,10-dimethyl-1,4,7,10-tetraazabicyclo[5.5.2]tetradecane Iron(II);

Dichloro-5,12-dimethyl-1,5,8,12-tetraazabicyclo[6.6.2]hexadecane Copper(II);

Dichloro-4,10-dimethyl-1,4,7,10-tetraazabicyclo[5.5.2]tetradecane Copper(II);

Dichloro-5,12-dimethyl-1,5,8,12-tetraazabicyclo[6.6.2]hexadecane Cobalt(II);

Dichloro-4,10-dimethyl-1,4,7,10-tetraazabicyclo[5.5.2]tetradecane Cobalt(II);

Dichloro 5,12-dimethyl—4-phenyl-1,5,8,12-tetraazabicyclo[6.6.2]hexadecane Manganese(II);

Dichloro-4,10-dimethyl-3-phenyl-1,4,7,10-tetraazabicyclo[5.5.2]tetradecane Manganese(II);

Dichloro-5,12-dimethyl-4,9-diphenyl-1,5,8,12-tetraazabicyclo[6.6.2]hexadecane Manganese(II);

Dichloro-4,10-dimethyl-3,8-diphenyl-1,4,7,10-tetraazabicyclo[5.5.2]tetradecane Manganese(II);

Dichloro-5,12-dimethyl-2,11-diphenyl-1,5,8,12-tetraazabicyclo[6.6.2]hexadecane Manganese(II);

Dichloro-4,10-dimethyl-4,9-diphenyl-1,4,7,10-tetraazabicyclo[5.5.2]tetradecane Manganese(II);

Dichloro-2,4,5,9,11,12-hexamethyl-1,5,8,12-tetraazabicyclo[6.6.2]hexadecane Manganese(II);

Dichloro-2,3,5,9,10,12-hexamethyl-1,5,8,12-tetraazabicyclo[6.6.2]hexadecane Manganese(II);

Dichloro-2,2,4,5,9,9,11,12-octamethyl-1,5,8,12-tetraazabicyclo[6.6.2]hexadecane Manganese(II);

Dichloro-2,2,4,5,9,11,11,12-octamethyl-1,5,8,12-tetraazabicyclo[6.6.2]hexadecane Manganese(II);

Dichloro-3,3,5,10,10,12-hexamethyl-1,5,8,12-tetraazabicyclo[6.6.2]hexadecane Manganese(II);

Dichloro-3,5,10,12-tetramethyl-1,5,8,12-tetraazabicyclo[6.6.2]hexadecane Manganese(II);

Dichloro-3-butyl-5,10,12-trimethyl-1,5,8,12-tetraazabicyclo[6.6.2]hexadecane Manganese(II);

Dichloro-1,5,8,12-tetraazabicyclo[6.6.2]hexadecane Manganese(II);

Dichloro-1,4,7,10-tetraazabicyclo[5.5.2]tetradecane Manganese(II);

Dichloro-1,5,8,12-tetraazabicyclo[6.6.2]hexadecane Iron(II);

Dichloro-1,4,7,10-tetraazabicyclo[5.5.2]tetradecane Iron(II);

Aquo-chloro-2-(2-hydroxyphenyl)-5,12-dimethyl1,5,8,12-tetraazabicyclo[6.6.2]hexadecane Manganese(II);

Aquo-chloro-10-(2-hydroxybenzyl)-4,10-dimethyl-1,4,7,10-tetraazabicyclo[5.5.2]tetradecane Manganese(II);

Chloro-2-(2-hydroxybenzyl)-5-methyl1,5,8,12-tetraazabicyclo[6.6.2]hexadecane Manganese(II);

Chloro-10-(2-hydroxybenzyl)-4-methyl-1,4,7,10-tetraazabicyclo[5.5.2]tetradecane Manganese(II);

Chloro-5-methyl-12-(2-picolyl)-1,5,8,12-tetraazabicyclo[6.6.2]hexadecane Manganese(I) Chloride;

Chloro-4-methyl-10-(2-picolyl)-1,4,7,10-tetraazabicyclo[5.5.2]tetradecane Manganese(II) Chloride;

Dichloro-5-(2-sulfato)dodecyl-12-methyl-1,5,8,12-tetraazabicyclo[6.6.2]hexadecane Manganese(III);

Aquo-Chloro-5-(2-sulfato)dodecyl-12-methyl-1,5,8,12-tetraazabicyclo[6.6.2]hexadecane Manganese(II);

Aquo-Chloro-5-(3-sulfonopropyl)-12-methyl-1,5,8,12-tetraazabicyclo[6.6.2]hexadecane Manganese(II);

Dichloro-5-(Trimethylammoniopropyl)dodecyl-12-methyl-1,5,8,12-tetraazabicyclo[6.6.2]hexadecane Manganese(III) Chloride;

Dichloro-5,12-dimethyl-1,4,7,10,13-pentaazabicyclo[8.5.2]heptadecane Manganese(II);

Dichloro-14,20-dimethyl-1,10,14,20-tetraazatriyclo[8.6.6]docosa-3(8),4,6-triene Manganese(II);

Dichloro-4,11-dimethyl-1,4,7,11-tetraazabicyclo[6.5.2]pentadecane Manganese(II);

Dichloro-5,12-dimethyl-1,5,8,12-tetraazabicyclo[7.6.2]heptadecane Manganese(II);

Dichloro-5,13-dimethyl-1,5,9,1 3-tetraazabicyclo[7.7.2]heptadecane Manganese(II);

Dichloro-3,10-bis(butylcarboxy)-5,12-dimethyl-1,5,8,12-tetraazabicyclo[6.6.2]hexadecane Manganese(II);

Diaquo-3,10-dicarboxy-5,12-dimethyl-1,5,8,12-tetraazabicyclo[6.6.2]hexadecane Manganese(II);

Chloro-20-methyl-1,9,20,24,25-pentaaza-tetracyclo[7.7.7.1^{3,7}.1^{11,15}.]pentacosa-3,5,7(24),11,13,15(25)-hexaene manganese(II) Hexafluorophosphate;

Trifluoromethanesulfono-20-methyl-1,9,20,24,25-pentaaza-tetracyclo[7.7.7.1^{3,7}.1^{11,15}.]pentacosa-3,5,7(24),11,13,15(25)-hexaene Manganese(II) Trifluoromethanesulfonate;

Trifluoromethanesulfono-20-methyl-1,9,20,24,25-pentaaza-tetracyclo[7.7.7.1^{3,7}.1^{11,15}.]pentacosa-3,5,7(24),11,13,15(25)-hexaene Iron(II) Trifluoromethanesulfonate;

Chloro-5,12,17-trimethyl-1,5,8,12,17-pentaazabicyclo[6.6.5]nonadecane Manganese(II) Hexafluorophosphate;

Chloro-4,10,15-trimethyl-1,4,7,10,15-pentaazabicyclo[5.5.5]heptadecane Manganese(II) Hexafluorophosphate;

Chloro-5,12,17-trimethyl-1,5,8,12,17-pentaazabicyclo[6.6.5]nonadecane Manganese(II) Chloride;

Chloro-4,10,15-trimethyl-1,4,7,10,15-pentaazabicyclo[5.5.5]heptadecane Manganese(II) Chloride;

Dichloro 5,12,15,16-tetramethyl-1,5,8,12-tetraazabicyclo[6.6.2]hexadecane Manganese(II); and

Chloro 5-methyl-12-(2′-oxybenzyl)-1,5,8,12-tetraazabicyclo[6.6.2]hexadecane Manganese(II).

Further suitable complexes useful as transition-metal bleach catalysts further include not only monometallic, mononuclear kinds such as those illustrated hereinabove but also bimetallic, trimetallic or cluster kinds. Monometallic, mononuclear complexes are preferred. As defined herein, a monometallic transition-metal bleach catalyst contains only one transition metal atom per mole of complex. A monometallic, mononuclear complex is one in which any donor atoms of the essential macrocyclic ligand are bonded to the same transition metal atom, that is, the essential ligand does not “bridge” across two or more transition-metal atoms.

Further examples of manganese transition metal complexes are the manganese(III) and manganese(IV) complexes having the general formula:

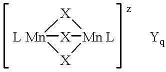

wherein X is independently a coordinating or bridging species non-limiting examples of which are H₂O, O₂²⁻, O²⁻, ⁻OH, HO₂⁻, SH⁻, S²⁻, >SO, Cl⁻, SCN⁻, N₃⁻, N³⁻, RSO₃⁻, RCOO⁻, NH₂⁻, and NR₃, wherein R is H alkyl, aryl, each of which is optionally substituted, and R¹COO, wherein R¹ is an alkyl, aryl unit, each of which may be optionally substituted;

L is a ligand which is an organic molecule containing a number of nitrogen atoms which co-ordinate via all or some of said nitrogen atoms to the manganese centers;

z denotes the charge of the complex and is an integer which can have a positive or negative value;

Y is a monovalent or multivalent counter-ion, which provides charge neutrality, which dependent upon the charge z of the complex; and q is z/Y.

Preferred of these manganese complexes are those wherein said coordinating or bridging group X is either CH₃COO⁻, O²⁻ and mixtures thereof, preferably when said manganese atom is in the (IV) oxidation state and X is O²⁻. Ligands which are preferred are those which contain at least three nitrogen atoms and which coordinate via three nitrogen atoms to one of the manganese centers and are preferably of a macrocyclic nature.

Preferred ligands have the formula:

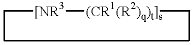

wherein t is an integer having the value 2 or 3; s is an integer having the value 3 or 4; q is an integer having the value 0 or 1, R¹ and R² are each independently selected from hydrogen, alkyl, aryl, each of which can be optionally substituted; R³ is independently selected from hydrogen, alkyl, aryl, each of which can be optionally substituted.

Non-limiting examples of preferred ligands are 1,4,7-trimethyl-1,4,7-triazacyclononane (Me₃-TACN), and 1,2,4,7-tetramethyl-1,4,7-triazacyclononane (Me₄-TACN).

The selection of the counter ion Y for establishing charge neutrality is not critical for the activity of the complex. Non-limiting examples of said counter ions are chloride, sulphate, nitrate, methylsulphate, surfactant-ions, such as long chain alkylsulphates, alkylsulphonates, alkylbenzenesulphonates, tosylate, trifluoromethylsulphonate, perchlorate, BPh₄⁻, PF₆⁻, and mixtures thereof.

Examples of manganese complexes of this type include:

i) [(Me₃-TACN)Mn^{IV}(m-O)₃Mn^{IV}(Me₃-TACN)]²⁺(PF₆⁻)₂;

ii) [(Me₄-TACN)Mn^{IV}(m-O)₃Mn^{IV}(Me₄-TACN)]²⁺(PF₆⁻)₂;

iii) [(Me₃-TACN)Mn^{III}(m-O)(m-OAc)₂Mn^{III}(Me₃-TACN)]²⁺(PF₆⁻)₂;

iv) [(Me₄-TACN)Mn^{III}(m-O)(m-OAc)₂Mn^{III}(Me₄-TACN)]²⁺(PF₆⁻)₂;

Further manganese complex catalysts are the mononuclear complexes having the formula:

[LMn^{IV}(OR)₃]Y

wherein manganese, Mn, is in the +4 oxidation state; R is C₁-C₂₀ radical selected from the group consisting of alkyl, cycloalkyl, aryl, benzyl, and radical combinations thereof; at least two R radicals may also be connected to one another so as to form a bridging unit between two oxygens that coordinate with the manganese; L is a ligand selected from a C₃-C₆₀ radical having at least 3 nitrogen atoms coordinating with the manganese; and Y is an oxidatively-stable counterion dependent upon the charge of the complex.

Non-limiting examples of preferred complexes are those wherein L is 1,4,7-trimethyl-1,4,7-triazacyclononane, and 2 methyl-1,4,7-trimethyl-1,4,7-triazacyclononane, and R is C₁ alkyl.

Further examples of mononuclear manganese complex catalysts which are capable of bleaching in the absence of a source of hydrogen peroxide or other peroxygen bleaching agent include those having the formula:

[LMnXₚ]^{Z}Y_{q}

wherein manganese can be in any of the II, III, or IV oxidation sates; each X independently represents a coordinating species with the exception of RO⁻, such as Cl⁻, Br⁻, I⁻, F⁻, NCS⁻, N₃⁻, I₃⁻, NH₃, RCOO⁻, RSO₃⁻, RSO₄⁻, in which R is alkyl or aryl wherein each can be optionally substituted, OH⁻, O₂²⁻, HO₂⁻, H₂O, SH, CN⁻, OCN⁻, S₄²⁻, and mixtures thereof; p is an integer from 1 to 3; z denotes the charge of the complex and is an integer which can be positive, zero, or negative; Y is a counter-ion the selection of which dependent upon the charge z of the complex; q=z/Y; and L is a ligand having the formula:

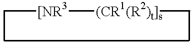

wherein t is 2; s is 3; R¹, R² and R³ are each independently selected from hydrogen, C₁-C₆ alkyl, aryl, each of which can be optionally substituted.

A particularly useful metal bleach catalyst is [Mn(Bcyclam)Cl2]:

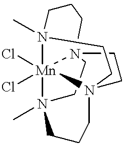

“Bcyclam” (5,12-dimethyl-1,5,8,12-tetraaza-bicyclo[6.6.2]hexadecane) is prepared according to J. Amer. Chem. Soc., (1990), 112, 8604.

These catalysts may be co-processed with adjunct materials so as to reduce the colour impact if desired for the aesthetics of the product, or to be included in enzyme-containing particles as exemplified hereinafter, or the tablets may be manufactured to contain catalyst “speckles”.

Enzymes

Enzymes are preferred components of the tablets as disclosed herein. Where present said enzymes are selected from the group consisting of cellulases, hemicellulases, peroxidases, proteases, gluco-amylases, amylases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase or mixtures thereof.

Preferred enzymes include protease, amylase, lipase, peroxidases, cutinase and/or cellulase in conjunction with one or more plant cell wall degrading enzymes.

The cellulases usable in the present invention include both bacterial or fungal cellulase. Preferably, they will have a pH optimum of between 5 and 12 and an activity above 50 CEVU (Cellulose Viscosity Unit). Suitable cellulases are disclosed in U.S. Pat. No. 4,435,307, Barbesgoard et al, J61078384 and W096/02653 which disclose fungal cellulases produced respectively from Humicola insolens, Trichoderma, Thielavia and Sporotrichum. EP 739 982 describes cellulases isolated from novel Bacillus species. Suitable cellulases are also disclosed in GB-A-2.075.028; GB-A-2.095.275; DE-OS-2.247.832 and WO95/26398.

Examples of such cellulases are cellulases produced by a strain of Humicola insolens (Humicola grisea var. thermoidea), particularly the Humicola strain DSM 1800. Other suitable cellulases are cellulases originated from Humicola insolens having a molecular weight of 50 KDa, an isoelectric point of 5.5 and containing 415 amino acids; and a ^{˜}43 kD endoglucanase derived from Humicola insolens, DSM 1800, exhibiting cellulase activity; a preferred endoglucanase component has the amino acid sequence disclosed in PCT Patent Application No. WO 91/17243. Also suitable cellulases are the EGIII cellulases from Trichoderma longibrachiatum described in WO94/21801, Genencor, published Sep. 29, 1994. Especially suitable cellulases are the cellulases having color care benefits. Examples of such cellulases are cellulases described in European patent application No. 91202879.2, filed Nov. 6, 1991 (Novo). Carezyme® and Celluzyme® (Novo Nordisk A/S) are especially useful. See also WO91/17244 and WO91/21801. Other suitable cellulases for fabric care and/or cleaning properties are described in WO96/34092, WO96/17994 and WO95/24471.

Said cellulases are normally incorporated in the tablets at levels from 0.0001% to 2% of active enzyme by weight of the tablets.

Peroxidase enzymes are used in combination with oxygen sources, e.g. percarbonate, perborate, persulfate, hydrogen peroxide, etc. They are used for “solution bleaching”, i.e. to prevent transfer of dyes or pigments removed from substrates during wash operations to other substrates in the wash solution. Peroxidase enzymes are known in the art, and include, for example, horseradish peroxidase, ligninase and haloperoxidase such as chloro- and bromo-peroxidase. Peroxidase-containing detergent compositions are disclosed, for example, in PCT International Application WO 89/099813, WO89/09813 and in European Patent application EP No. 91202882.6, filed on Nov. 6, 1991 and EP No. 96870013.8, filed Feb. 20, 1996. Also suitable is the laccase enzyme.

Preferred enhancers are substitued phenthiazine and phenoxasine 10-Phenothiazinepropionicacid (PPT), 10-ethylphenothiazine-4-carboxylic acid (EPC), 10-phenoxazinepropionic acid (POP) and 10-methylphenoxazine (described in WO 94/12621) and substitued syringates (C3-C5 substitued alkyl syringates) and phenols. Sodium percarbonate or perborate are preferred sources of hydrogen peroxide.

Said cellulases and/or peroxidases are normally incorporated in the tablets at levels from 0.0001% to 2% of active enzyme by weight of the tablets.

Other preferred enzymes that can be included in the tablets of the present invention include lipases. Suitable lipase enzymes for detergent usage include those produced by microorganisms of the Pseudomonas group, such as Pseudomonas stutzeri ATCC 19.154, as disclosed in British Patent 1,372,034. Suitable lipases include those which show a positive immunological cross-reaction with the antibody of the lipase, produced by the microorganism Pseudomonas fluorescent IAM 1057. This lipase is available from Amano Pharmaceutical Co. Ltd., Nagoya, Japan, under the trade name Lipase P “Amano,” hereinafter referred to as “Amano-P”. Other suitable commercial lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., The Netherlands, and lipases ex Pseudomonas gladioli. Especially suitable lipases are lipases such as M1 Lipasee and Lipomax® (Gist-Brocades) and Lipolase® and Lipolase Ultra® (Novo) which have found to be very effective when used in combination with the compositions of the present invention. Also suitables are the lipolytic enzymes described in EP 258 068, WO 92/05249 and WO 95/22615 by Novo Nordisk and in WO 94/03578, WO 95/35381 and WO 96/00292 by Unilever.

Also suitable are cutinases [EC 3.1.1.50] which can be considered as a special kind of lipase, namely lipases which do not require interfacial activation. Addition of cutinases to detergent compositions has been described in e.g. WO-A-88/09367 (Genencor); WO 90/09446 (Plant Genetic System) and WO 94/14963 and WO 94/14964 (Unilever).

The lipases and/or cutinases are normally incorporated in the tablets at levels from 0.0001% to 2% of active enzyme by weight of the tablets.

Suitable proteases are the subtilisins which are obtained from particular strains of B. subtilis and B. licheniformis (subtilisin BPN and BPN′). One suitable protease is obtained from a strain of Bacillus, having maximum activity throughout the pH range of 8-12, developed and sold as ESPERASE®) by Novo Industries A/S of Denmark, hereinafter “Novo”. The preparation of this enzyme and analogous enzymes is described in GB 1,243,784 to Novo. Other suitable proteases include ALCALASE®, DURAZYM® and SAVINASE® from Novo and MAXATASE®, MAXACAL®, PROPERASE® and MAXAPEM® (protein engineered Maxacal) from Gist-Brocades. Proteolytic enzymes also encompass modified bacterial serine proteases, such as those described in European Patent Application Ser. Number 87 303761.8, filed Apr. 28, 1987 (particularly pages 17, 24 and 98), and which is called herein “Protease B”, and in European Patent Application 199,404, Venegas, published October 29, 1986, which refers to a modified bacterial serine protealytic enzyme which is called “Protease A” herein. Suitable is what is called herein “Protease C”, which is a variant of an alkaline serine protease from Bacillus in which lysine replaced arginine at position 27, tyrosine replaced valine at position 104, serine replaced asparagine at position 123, and alanine replaced threonine at position 274. Protease C is described in EP 90915958:4, corresponding to WO 91/06637, Published May 16, 1991. Genetically modified variants, particularly of Protease C, are also included herein.

A preferred protease referred to as “Protease D” is a carbonyl hydrolase variant having an amino acid sequence not found in nature, which is derived from a precursor carbonyl hydrolase by substituting a different amino acid for a plurality of amino acid residues at a position in said carbonyl hydrolase equivalent to position +76, preferably also in combination with one or more amino acid residue positions equivalent to those selected from the group consisting of +99, +101, +103, +104, +107, +123, +27, +105, +109, +126, +128, +135, +156, +166, +195, +197, +204, +206, +210, +216, +217, +218, +222, +260, +265, and/or +274 according to the numbering of Bacillus amyloliquefaciens subtilisin, as described in W095/10591 and in the patent application of C. Ghosh, et al, “Bleaching Compositions Comprising Protease Enzymes” having U.S. Ser. No. 08/322,677, filed Oct. 13, 1994.

Also suitable for the present invention are proteases described in patent applications EP 251 446 and WO 91/06637, protease BLAP® described in WO91/02792 and their variants described in WO 95/23221.

See also a high pH protease from Bacillus sp. NCIMB 40338 described in WO 93/18140 A to Novo. Enzymatic detergents comprising protease, one or more other enzymes, and a reversible protease inhibitor are described in WO 92/03529 A to Novo. When desired, a protease having decreased adsorption and increased hydrolysis is available as described in WO 95/07791 to Procter & Gamble. A recombinant trypsin-like protease for detergents suitable herein is described in WO 94/25583 to Novo. Other suitable proteases are described in EP 516 200 by Unilever.

Other preferred protease enzymes include protease enzymes which are a carbonyl hydrolase variant having an amino acid sequence not found in nature, which is derived by replacement of a plurality of amino acid residues of a precursor carbonyl hydrolase with different amino acids, wherein said plurality of amino acid residues replaced in the precursor enzyme correspond to position +210 in combination with one or more of the following residues: +33, +62, +67, +76, +100, +101, +103, +104, +107, +128, +129, +130, +132, +135, +156, +158, +164, +166, +167, +170, +209, +215, +217, +218 and +222, where the numbered positions correspond to naturally-occurring subtilisin from Bacillus amyloliquefaciens or to equivalent amino acid residues in other carbonyl hydrolases or subtilisins (such as Bacillus lentus subtilisin). Preferred enzymes of this type include those having position changes +210, +76, +103, +104, +156, and +166.

The proteolytic enzymes are incorporated in the tablets of the present invention a level of from 0.0001% to 2%, preferably from 0.001% to 0.2%, more preferably from 0.005% to 0.1% pure enzyme by weight of the tablet.

Amylases (α and/or β) can be included for removal of carbohydrate-based stains. WO94/02597, Novo Nordisk A/S published Feb. 3, 1994, describes cleaning compositions which incorporate mutant amylases. See also WO95/10603, Novo Nordisk A/S, published Apr. 20, 1995. Other amylases known for use in cleaning compositions include both α- and β-amylases. 3s Amylases are known in the art and include those disclosed in U.S. Pat. No. 5,003,257; EP 252,666; WO/91/00353; FR 2,676,456; EP 285,123; EP 525,610; EP 368,341; and British Patent specification no. 1,296,839 (Novo). Other suitable amylases are stability-enhanced amylases described in WO94/18314, published Aug. 18, 1994 and WO96/05295, Genencor, published Feb. 22, 1996 and amylase variants having additional modification in the immediate parent available from Novo Nordisk A/S, disclosed in WO 95/10603, published April 95. Also suitable are amylases described in EP 277 216, WO95/26397 and WO96/23873 (all by Novo Nordisk).

Examples of commercial α-amylases products are Purafect Ox Am® from Genencor and Termamyl®, Ban® Fungamyl® and Duramyl®, Natalase® all available from Novo Nordisk A/S Denmark. WO95/26397 describes other suitable amylases: α-amylases characterised by having a specific activity at least 25% higher than the specific activity of Termamyl® at a temperature range of 25° C. to 55° C. and at a pH value in the range of 8 to 10, measured by the Phadebas® α-amylase activity assay. Suitable are variants of the above enzymes, described in WO96/23873 (Novo Nordisk). Other amylolytic enzymes with improved properties with respect to the activity level and the combination of thermostability and a higher activity level are described in WO95/35382.

Preferred amylase enzymes include those described in WO95/26397 and in co-pending application by Novo Nordisk PCT/DK96/00056.

The amylolytic enzymes are incorporated in the tablets of the present invention a level of from 0.0001% to 2%, preferably from 0.00018% to 0.06%, more preferably from 0.00024% to 0.048% pure enzyme by weight of the tablet

In a particularly preferred embodiment, detergent tablets of the present invention comprise amylase enzymes, particularly those described in WO95/26397 and co-pending application by Novo Nordisk PCT/DK96/00056 in combination with a complementary amylase.

By “complementary” it is meant the addition of one or more amylase suitable for detergency purposes. Examples of complementary amylases (αand/or B) are described below. WO94/02597 and WO95/10603, Novo Nordisk A/S describe cleaning compositions which incorporate mutant amylases. Other amylases known for use in cleaning compositions include both α- and β-amylases. α-Amylases are known in the art and include those disclosed in U.S. Pat. No. 5,003,257; EP 252,666; WO/91/00353; FR 2,676,456; EP 285,123; EP 525,610; EP 368,341; and British Patent specification no. 1,296,839 (Novo). Other suitable amylases are stability-enhanced amylases described in WO94/18314, and W096/05295, Genencor and amylase variants having additional modification in the immediate parent available from Novo Nordisk A/S, disclosed in WO 95/10603. Also suitable are amylases described in EP 277 216 (Novo Nordisk). Examples of commercial α-amylases products are Purafect Ox Am® from Genencor and Termamyl®, Ban® ,Fungamyl® and Duramyl(®, all available from Novo Nordisk A/S Denmark. W095/26397 describes other suitable amylases : α-amylases characterised by having a specific activity at least 25% higher than the specific activity of Termamyl® at a temperature range of 25° C. to 55° C. and at a pH value in the range of 8 to 10, measured by the Phadebas® α-amylase activity assay. Suitable are variants of the above enzymes, described in WO96/23873 (Novo Nordisk). Other amylolytic enzymes with improved properties with respect to the activity level and the combination of thermostability and a higher activity level are described in WO95/35382. Preferred complementary amylases for the present invention are the amylases sold under the tradename Purafect Ox AmR described in WO 94/18314, WO96/05295 sold by Genencor; Termamyl®, Fungamyl®, Ban® Natalase® and Duramyl®, all available from Novo Nordisk A/S and Maxamyl® by Gist-Brocades.

Said complementary amylase is generally incorporated in the tablets of the present invention a level of from 0.0001% to 2%, preferably from 0.00018% to 0.06%, more preferably from 0.00024% to 0.048% pure enzyme by weight of the tablet. Preferably a weight of pure enzyme ratio of specific amylase to the complementary amylase is comprised between 9:1 to 1:9, more preferably between 4:1 to 1:4, and most preferably between 2:1 and 1:2.

The above-mentioned enzymes may be of any suitable origin, such as vegetable, animal, bacterial, fungal and yeast origin. Origin can further be mesophilic or extremophilic (psychrophilic, psychrotrophic, thermophilic, barophilic, alkalophilic, acidophilic, halophilic, etc.). Purified or non-purified forms of these enzymes may be used. Also included by definition, are mutants of native enzymes. Mutants can be obtained e.g. by protein and/or genetic engineering, chemical and/or physical modifications of native enzymes. Common practice as well is the expression of the enzyme via host organisms in which the genetic material responsible for the production of the enzyme has been cloned.

Said enzymes are normally incorporated in the tablets herein at levels from 0.0001% to 2% of active enzyme by weight of the tablets. The enzymes can be added as separate single ingredients (prills, granulates, stabilized liquids, etc. containing one enzyme ) or as mixtures of two or more enzymes (e.g. cogranulates ).

Other suitable detergent ingredients that can be added are enzyme oxidation scavengers which are described in Copending European Patent application 92870018.6 filed on Jan. 31, 1992. Examples of such enzyme oxidation scavengers are ethoxylated tetraethylene polyamines.

A range of enzyme materials and means for their incorporation into synthetic detergent compositions is also disclosed in WO 9307263 A and WO 9307260 A to Genencor International, WO 8908694 A to Novo, and U.S. Pat. No. 3,553,139, Jan. 5, 1971 to McCarty et al. Enzymes are further disclosed in U.S. Pat. No. 4,101,457, Place et al, Jul. 18, 1978, and in U.S. Pat. No. 4,507,219, Hughes, Mar. 26, 1985. Enzyme materials useful for liquid detergent formulations, and their incorporation into such formulations, are disclosed in U.S. Pat. No. 4,261,868, Hora et al, Apr. 14, 1981. Enzymes for use in detergents can be stabilised by various techniques. Enzyme stabilisation techniques are disclosed and exemplified in U.S. Pat. No. 3,600,319, Aug. 17, 1971, Gedge et al, EP 199,405 and EP 200,586, Oct. 29, 1986, Venegas. Enzyme stabilisation systems are also described, for example, in U.S. Pat. No. 3,519,570. A useful Bacillus, sp. AC13 giving proteases, xylanases and cellulases, is described in WO 9401532 A to Novo.

Effervescent

In another preferred embodiment of the present invention the tablets further comprise an effervescent.

Effervescency as defined herein means the evolution of bubbles of gas from a liquid, as the result of a chemical reaction between a soluble acid source and an alkali metal carbonate, to produce carbon dioxide gas,

i.e. C₆H₈O₇+3NaHCO₃→Na₃C₆H₅O₇+3CO₂+3H₂O

Further examples of acid and carbonate sources and other effervescent systems may be found in: Pharmaceutical Dosage Forms: Tablets Volume 1 Page 287 to 291.

An effervescent may be added to the tablet as described herein. The addition of this effervescent to the detergent tablet improves the disintegration time of the tablet. The amount will preferably be between 5% and 20% and most preferably between 10% and 20% by weight of the tablet. Preferably the effervescent should be added as an agglomerate of the different particles or as a compact, and not as separated particles.

Due to the gas created by the effervescency in the tablet, the tablet can have a higher tablet integrity and still have the same disintegration time as a tablet without effervescency.

Further dispersion aid could be provided by using compounds such as sodium acetate or urea. A list of suitable dispersion aid may also be found in Pharmaceutical Dosage Forms: Tablets, Volume 1, Second edition, Edited by H. A. Lieberman et all, ISBN 0-8247-8044-2.

Builders

Detergent builders can optionally be included in the tablets herein to assist in controlling mineral hardness. Inorganic as well as organic builders can be used. Builders are typically used in fabric laundering compositions to assist in the removal of particulate soils.

The level of builder can vary widely depending upon the end use of the composition.

Inorganic or P-containing detergent builders include, but are not limited to, the alkali metal, ammonium and alkanolammonium salts of polyphosphates (exemplified by the tripolyphosphates, pyrophosphates, and glassy polymeric meta-phosphates), phosphonates, phytic acid, silicates, carbonates (including bicarbonates and sesquicarbonates), sulphates, and aluminosilicates. However, non-phosphate builders are required in some locales. Importantly, the compositions herein function surprisingly well even in the presence of the so-called “weak” builders (as compared with phosphates) such as citrate, or in the so-called “underbuilt” situation that may occur with zeolite or layered silicate builders.

Examples of silicate builders are the alkali metal silicates, particularly those having a SiO₂:Na₂O ratio in the range 1.6:1 to 3.2:1 and layered silicates, such as the layered sodium silicates described in U.S. Pat. No. 4,664,839, issued May 12, 1987 to H. P. Rieck. NaSKS-6® is the trademark for a crystalline layered silicate marketed by Hoechst (commonly abbreviated herein as “SKS-6”). Unlike zeolite builders, the Na SKS-6 silicate builder does not contain aluminum. NaSKS-6® has the delta-Na₂SiO₅ morphology form of layered silicate. It can be prepared by methods such as those described in German DE-A-3,417,649 and DE-A-3,742,043. SKS-6 is a highly preferred layered silicate for use herein, but other such layered silicates, such as those having the general formula NaMSixO₂x+1.yH₂O wherein M is sodium or hydrogen, x is a number from 1.9 to 4, preferably 2, and y is a number from 0 to 20, preferably 0 can be used herein. Various other layered silicates from Hoechst include NaSKS-5, NaSKS-7 and NaSKS-1 1, as the alpha, beta and gamma forms. As noted above, the delta-Na₂SiO₅ (NaSKS-6) is most preferred for use herein. Other silicates may also be useful such as for example magnesium silicate, which can serve as a crispening agent in granular formulations, as a stabilizing agent for oxygen bleaches, and as a component of suds control systems.

Examples of carbonate builders are the alkaline earth and alkali metal carbonates as disclosed in German Patent Application No. 2,321,001 published on Nov. 15, 1973.

Aluminosilicate builders are useful in the present invention. Aluminosilicate builders are of great importance in most currently marketed heavy duty granular detergent compositions, and can also be a significant builder ingredient in liquid detergent formulations. Aluminosilicate builders include those having the empirical formula:

Mz(zAlO₂)y].xH₂O

wherein z and y are integers of at least 6, the molar ratio of z to y is in the range from 1.0 to about 0.5, and x is an integer from about 15 to about 264.

Useful aluminosilicate ion exchange materials are commercially available. These aluminosilicates can be crystalline or amorphous in structure and can be naturally-occurring aluminosilicates or synthetically derived. A method for producing aluminosilicate ion exchange materials is disclosed in U.S. Pat. No. 3,985,669, Krummel, et al, issued Oct. 12, 1976. Preferred synthetic crystalline aluminosilicate ion exchange materials useful herein are available under the designations Zeolite A, Zeolite P (B), Zeolite MAP and Zeolite X. In an especially preferred embodiment, the crystalline aluminosilicate ion exchange material has the formula:

Na₁₂[(AlO₂)₁₂(SiO₂)₁₂].xH₂O

wherein x is from about 20 to about 30, especially about 27. This material is known as Zeolite A. Dehydrated zeolites (x=0-10) may also be used herein. Preferably, the aluminosilicate has a particle size of about 0.1-10 microns in diameter.

Organic detergent builders suitable for the purposes of the present invention include, but are not restricted to, a wide variety of polycarboxylate compounds. As used herein, “polycarboxylate” refers to compounds having a plurality of carboxylate groups, preferably at least 3 carboxylates. Polycarboxylate builder can generally be added to the composition in acid form, but can also be added in the form of a neutralized salt. When utilized in salt form, alkali metals, such as sodium, potassium, and lithium, or alkanolammonium salts are preferred.

Included among the polycarboxylate builders are a variety of categories of useful materials. One important category of polycarboxylate builders encompasses the ether polycarboxylates, including oxydisuccinate, as disclosed in Berg, U.S. Pat. No. 3,128,287, issued Apr. 7, 1964, and Lamberti et al., U.S. Pat. No. 3,635,830, issued Jan. 18, 1972. See also “TMS/TDS” builders of U.S. Pat. No. 4,663,071, issued to Bush et al., on May 5, 1987. Suitable ether polycarboxylates also include cyclic compounds, particularly alicyclic compounds, such as those described in U.S. Pat. Nos. 3,923,679; 3,835,163; 4,158,635; 4,120,874 and 4,102,903.

Other useful detergency builders include the ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Citrate builders, e.g., citric acid and soluble salts thereof (particularly sodium salt), are polycarboxylate builders of particular importance for heavy duty liquid detergent formulations due to their availability from renewable resources and their biodegradability. Citrates can also be used in granular compositions, especially in combination with zeolite and/or layered silicate builders. Oxydisuccinates are also especially useful in such compositions and combinations.

Also suitable in the detergent compositions of the present invention are the 3,3-dicarboxy-4-oxa-1,6-hexanedioates and the related compounds disclosed in U.S. Pat. No. 4,566,984, Bush, issued Jan. 28, 1986. Useful succinic acid builders include the C5-C20 alkyl and alkenyl succinic acids and salts thereof. A particularly preferred compound of this type is dodecenylsuccinic acid. Specific examples of succinate builders include: laurylsuccinate, myristylsuccinate, palmitylsuccinate, 2-dodecenylsuccinate (preferred), 2-pentadecenylsuccinate, and the like. Laurylsuccinates are the preferred builders of this group, and are described in European Patent Application 86200690.5/0,200,263, published Nov. 5, 1986.

Other suitable polycarboxylates are disclosed in U.S. Pat. No. 4,144,226, Crutchfield et al., issued Mar. 13, 1979, and in U.S. Pat. No. 3,308,067, Diehl, issued Mar. 7, 1967. See also Diehl U.S. Pat. No. 3,723,322.

Fatty acids, e.g., C12-C18 monocarboxylic acids, can also be incorporated into the compositions alone, or in combination with the aforesaid builders, especially citrate and/or the succinate builders, to provide additional builder activity. Such use of fatty acids will generally result in a diminution of sudsing, which should be taken into account by the formulator.

In situations where phosphorus-based builders can be used, and especially in the formulation of bars used for hand-laundering operations, the various alkali metal phosphates such as the well-known sodium tripolyphosphates, sodium pyrophosphate and sodium orthophosphate can be used. Phosphonate builders such as ethane-1-hydroxy-1,1-diphosphonate and other known phosphonates (see, for example, U.S. Pat. Nos. 3,159,581; 3,213,030; 3,422,021; 3,400,148 and 3,422,137) can also be used.

Clays

As an optional ingredient the tablets herein may comprise a clay. Clay provides a fabric softening and/or ease of ironing benefit to the tablets of the present invention.

The tablet according to the present invention may have a concentration of clay of greater than 1% by weight of the tablet, preferably greater than 3%, and most preferably greater than 5% by weight of the tablet. Generally, the upper limit of clay content may be 60%, more preferably 45%, and most preferably 30% by weight of the tablet.

The clay is preferably mainly in the form of granules, with at least 50%, preferably at least 75%, and more preferable at least 90% being in the form of granules having a size of at least 0.1 mm up to 1.8 mm, preferably up to 1.18 mm, preferably from 0.15 mm to 0.85 mm. Preferably the amount of clay in the granules is at least 50%, more preferably at least 70% and most preferably at least 90% by weight of the granules.

Clay Flocculants

In a preferred embodiment wherein the detergent tables herein comprise clay, the tablets may further comprise a clay flocculating polymers.

Most clay flocculating polymers are fairly long chained polymers and co-polymers derived from such monomers as ethylene oxide, acrylamide, acrylic acid, dimethylamino ethyl methacrylate, vinyl alcohol, vinyl pyrrolidone and ethylene imine. Gums, like guar gum, are suitable as well.

Preferred are polymers of ethylene oxide, acrylamide or acrylic acid. These polymers dramatically enhance the deposition of a fabric softening clay if their molecular weights are in the range of from 100 000 to 10 million. Preferred are such polymers having a weight average molecular weight of from 150000 to 5 million.

The most preferred polymer is poly (ethylene oxide). Molecular weight distributions can be readily determined using gel permeation chromatography, against standards of poly (ethylene oxide) of narrow molecular weight distributions.

The amount of clay flocculating polymers, when present, is preferably from 0.01% to 10%, most preferably from 0.1% to 5% by weight of the tablet.

The flocculant is preferably mainly in the form of granules, with at least 50% by weighty, preferably at least 75%, and most preferably at least 90% being in the form of granules having a size of at least 0.1 mm up to 1.8 mm, preferably up to 1.18 mm and most preferably from 0.15 mm to 0.85 mm Preferably the amount of flocculant in the granules is at least 50%, more preferably at least 70% and most preferably at least 90%, of the weight of the granules.

Binders

Non gelling binders may be integrated to the particles forming the tablet in order to further facilitate dispersion.

If non gelling binders are used, suitable non-gelling binders include synthetic organic polymers such as polyethylene glycols, polyvinylpyrrolidones, polyacrylates and water-soluble acrylate copolymers. The handbook of Pharmaceutical Excipients second edition, has the following binders classification: Acacia, Alginic Acid, Carbomer, Carboxymethylcellulose sodium, Dextrin, Ethylcellulose, Gelatin, Guar gum, Hydrogenated vegetable oil type 1, Hydroxyethyl cellulose, Hydroxypropyl methylcellulose, Liquid glucose, Magnesium aluminum silicate, Maltodextrin, Methylcellulose, polymethacrylates, povidone, sodium alginate, starch and zein. Most preferable binders also have an active cleaning function in the laundry wash such as cationic polymers, i.e. ethoxylated hexamethylene diamine quaternary compounds, bishexamethylene triamines, or others such as pentaamines, ethoxylated polyethylene amines, maleic acrylic polymers.

Non-gelling binder materials are preferably sprayed on and hence have an appropriate melting point temperature below 90° C., preferably below 70° C. and even more preferably below 50° C. so as not to damage or degrade the other active ingredients in the matrix. Most preferred are non-aqueous liquid binders (i.e. not in aqueous solution) which may be sprayed in molten form. However, they may also be solid binders incorporated into the matrix by dry addition but which have binding properties within the tablet.

Non-gelling binder materials are preferably used in an amount within the range from 0.1% to 15% by weight of the tablet, more preferably below 5% and especially if it is a non laundry active material below 2% by weight of the tablet.

It is preferred that gelling binders, such as nonionic surfactants are avoided in their liquid or molten form. Nonionic surfactants and other gelling binders are not excluded from the compositions, but it is preferred that they be processed into the detergent tablets as components of particulate materials, and not as liquids.

Detersive Surfactants

Non-limiting examples of surfactants useful herein typically at levels from 0.1% to 55%, by weight, anionics such as sulphonates, sulphates and ether sulphates. These include the conventional C11-C18 alkyl benzene sulfonates (“LAS”) and primary, branched-chain and random C10-C20 alkyl sulfates (“AS”), the C10-C18 secondary (2,3) alkyl sulfates of the formula CH₃(CH2)ₓ(CHOSO₃—M⁺)CH₃ and CH₃(CH₂)_{y}(CHOSO₃—M⁺)CH₂CH₃ where x and (y+1) are integers of at least about 7, preferably at least about 9, and M is a water-solubilizing cation, especially sodium, unsaturated sulfates such as oleyl sulfate, the C10-C18 alkyl alkoxy sulfates (“AExS”; especially EO 1-7 ethoxy sulfates), C10-C18 alkyl alkoxy carboxylates (especially the EO₁₋₅ ethoxycarboxylates), the C10-18 glycerol ethers, the C10-C18 alkyl polyglycosides and their corresponding sulfated polyglycosides, and C12-C18 alpha-sulfonated fatty acid esters. If desired, the conventional nonionic and amphoteric surfactants such as the C12-C18 alkyl ethoxylates (“AE”) including the so-called narrow peaked alkyl ethoxylates and C6-C12 alkyl phenol alkoxylates (especially ethoxylates and mixed ethoxy/propoxy), C12-C18 betaines and sulfobetaines (“sultaines”), C10-C18 amine oxides, and the like, can also be included in the overall compositions. The C10-C18 N-alkyl polyhydroxy fatty acid amides can also be used. Typical examples include the C12-C18 N-methylglucamides. See WO 92/06154. Other sugar-derived surfactants include the N-alkoxy polyhydroxy fatty acid amides, such as C10-C18 N-(3-methoxypropyl) glucamide. The N-propyl through N-hexyl C12-C18 glucamides can be used for low sudsing. C10-C20 conventional soaps may also be used. If high sudsing is desired, the branched-chain C10-C16 soaps may be used. Mixtures of anionic and nonionic surfactants are especially useful. Other conventional useful anionic, amphoteric, nonionic or cationic surfactants are listed in standard texts.

In preferred embodiments, the tablet comprises at least 0.1% by weight of surfactant, more preferably at least 0.5% by weight, even more preferably at least 1.0% by weight, and most preferably between 1.5% and 5% by weight of surfactant.

Other components which are commonly used in detergent compositions and which may be incorporated into the detergent tablets of the present invention include chelating agents, soil release agents, soil antiredeposition agents, dispersing agents, brighteners, suds suppressors, fabric softeners, dye transfer inhibition agents and perfumes.

Coating

Solidity of the tablet according to the invention may be further improved by making a coated tablet, the coating covering a non-coated tablet according to the invention, thereby further improving the mechanical characteristics of the tablet while maintaining or further improving dispersion.

In one embodiment of the present invention, the tablets may then be coated so that the tablet does not absorb moisture, or absorbs moisture at only a very slow rate. The coating is also strong so that moderate mechanical shocks to which the tablets are subjected during handling, packing and shipping result in no more than very low levels of breakage or attrition. Finally the coating is preferably brittle so that the tablet breaks up when subjected to stronger mechanical shock. Furthermore it is advantageous if the coating material is dispersed under alkaline conditions, or is readily emulsified by surfactants. This contributes to avoiding the problem of visible residue in the window of a front-loading washing machine during the wash cycle, and also avoids deposition of particles or lumps of coating material on the laundry load.

Water solubility is measured following the test protocol of ASTM E1148-87 entitled, “Standard Test Method for Measurements of Aqueous Solubility”.

Suitable coating materials are dicarboxylic acids. Particularly suitable dicarboxylic acids are selected from the group consisting of oxalic acid, malonic acid, succinic acid, glutaric acid, adipic acid, pimelic acid, suberic acid, azelaic acid, sebacic acid, undecanedioic acid, dodecanedioic acid, tridecanedioic acid and mixtures thereof. The coating material has a melting point preferably of from 40° C. to 200° C.

The coating can be applied in a number of ways. Two preferred coating methods are a) coating with a molten material and b) coating with a solution of the material.

In a), the coating material is applied at a temperature above its melting point, and solidifies on the tablet. In b), the coating is applied as a solution, the solvent being dried to leave a coherent coating. The substantially insoluble material can be applied to the tablet by, for example, spraying or dipping. Normally when the molten material is sprayed on to the tablet, it will rapidly solidify to form a coherent coating. When tablets are dipped into the molten material and then removed, the rapid cooling again causes rapid solidification of the coating material. Clearly substantially insoluble materials having a melting point below 40° C. are not sufficiently solid at ambient temperatures and it has been found that materials having a melting point above about 200° C. are not practicable to use. Preferably, the materials melt in the range from 60° C. to 160° C., more preferably from 70° C. to 120° C.

By “melting point” is meant the temperature at which the material when heated slowly in, for example, a capillary tube becomes a clear liquid.

A coating of any desired thickness can be applied according to the present invention. For most purposes, the coating forms from 1% to 10%, preferably from 1.5% to 5%, of the tablet weight.

The tablet coatings are preferably very hard and provide extra strength to the tablet.

In a preferred embodiment of the present invention the fracture of the coating in the wash is improved by adding a disintegrant in the coating. This disintegrant will swell once in contact with water and break the coating in small pieces. This will improve the dispersion of the coating in the wash solution. The disintegrant is suspended in the coating melt at a level of up to 30%, preferably between 5% and 20%, most preferably between 5 and 10% by weight. Possible disintegrants are described in Handbook of Pharmaceutical Excipients (1986). Examples of suitable disintegrants are listed in the above section describing the further disintagration agent.

Tablet Manufacture

The tablets of the present invention can be prepared simply by mixing the solid ingredients together and compressing the mixture in a conventional tablet press as used, for example, in the pharmaceutical industry. Preferably the principal ingredients, in particular gelling surfactants, when present, are used in particulate form. Any liquid ingredients, for example surfactant or suds suppressor, can be incorporated in a conventional manner into the solid particulate ingredients.

The ingredients such as builder and surfactant can be spray-dried in a conventional manner and then compacted at a suitable pressure. Preferably, the tablets according to the invention are compressed using a force of less than 100000N, more preferably of less than 50000N, even more preferably of less than 5000N and most preferably of less than 3000 N. Indeed, the most preferred embodiment is a tablet compressed using a force of less than 2500N.

The particulate material used for making the tablet of this invention can be made by any particulation or granulation process. An example of such a process is spray drying (in a co-current or counter current spray drying tower) which typically gives low bulk densities 600g/l or lower. Particulate materials of higher density can be prepared by granulation and densification in a high shear batch mixer/granulator or by a continuous granulation and densification process (e.g. using Lodige® CB and/or Lodige® KM mixers). Other suitable processes include fluid bed processes, compaction processes (e.g. roll compaction), extrusion, as well as any particulate material made by any chemical process like flocculation, crystallisation sentering, etc. Individual particles can also be any other particle, granule, sphere or grain.

The components of the particulate material may be mixed together by any conventional means. Batch is suitable in, for example, a concrete mixer, Nauta mixer, ribbon mixer or any other. Alternatively the mixing process may be carried out continuously by metering each component by weight on to a moving belt, and blending them in one or more drum(s) or mixer(s). Non-gelling binder can be sprayed on to the mix of some, or all of, the components of the particulate material. Other liquid ingredients may also be sprayed on to the mix of components either separately or premixed. For example perfume and slurries of optical brighteners may be sprayed. A finely divided flow aid (dusting agent such as zeolites, carbonates, silicas) can be added to the particulate material after spraying the binder, preferably towards the end of the process, to make the mix less sticky.

The tablets may be manufactured by using any compacting process, such as tabletting, briquetting, or extrusion, preferably tabletting. Suitable equipment includes a standard single stroke or a rotary press (such as Courtoy®, Korch®, Manesty®, or Bonals®). The tablets prepared according to this invention preferably have a diameter of between 20 mm and 60 mm, preferably of at least 35 and up to 55 mm, and a weight between 25 and 100 g. The ratio of height to diameter (or width) of the tablets is preferably greater than 1:3, more preferably greater than 1:2. The compaction pressure used for preparing these tablets need not exceed 100000 kN/m2, preferably not exceed 30000 kN/m2, more preferably not exceed 5000 kN/m2, even more preferably not exceed 300 kN/m2 and most preferably not exceed 1000 kN/m2. In a preferred embodiment according to the invention, the tablet has a density of at least 0.9 g/cc, more preferably of at least 1.0 g/cc, and preferably of less than 2.0 g/cc, more preferably of less than 1.5 g/cc, even more preferably of less than 1.25 g/cc and most preferably of less than 1.1 g/cc. Multi-phase can be made as described in the Applicant's patent application PCT/US99/15492 (attorney's docket number CM1805M5).

Multi-layer tablets can be made by known techniques.

### EXAMPLES

The following examples will further illustrate the present invention. The compositions are made by combining the listed ingredients in the listed proportions (weight % unless otherwise specified). The following Examples are meant to exemplify compositions used in a process according to the present invention but are not necessarily used to limit or otherwise define the scope of the present invention.

Abbreviations used in Examples

In the tablet compositions, the abbreviated component identifications have
the following meanings:

| | |
|---|---|
| STPP | Sodium tripolyphosphate |
| Bicarbonate | Sodium hydrogen carbonate |
| Citric Acid | Anhydrous Citric acid |
| Carbonate | Anhydrous sodium carbonate |
| PG2000-Na ® | Crosslinked polystyrene sulphonate ion exchange |
| | resin supplied by Purolite |
| Arbocel FDY600 ® | Cellulose fibres supplied by Rettenmaier |
| Vivapur 200 ® | Microcrystalline cellulose supplied by Rettenmaier |
| Silicate | Amorphous Sodium Silicate (SiO₂:Na₂O ratio = |
| | 2.0) |
| SKS-6 | Crystalline layered silicate of formula δ-Na₂Si₂O₅ |
| PB1 | Anhydrous sodium perborate monohydrate |
| Nonionic | C₁₃-C₁₅ mixed ethoxylated/propoxylated fatty |
| | alcohol with an average degree of ethoxylation of |
| | 3.8 and an average degree of propoxylation of 4.5, |
| | sold under the tradename Plurafac by BASF |
| TAED | Tetraacetyl ethylene diamine |
| HEDP | Ethane 1-hydroxy-1, 1-diphosphonic acid |
| DTPMP | Diethylene triamine penta methylene phosphonic |
| | acid |
| ATMP | Amino trimethylene phosphonic acid |
| PAAC | Pentaamine acetate cobalt (III) salt |
| Paraffin | Paraffin oil sold under the tradename Winog 70 by |
| | Wintershall. |
| Protease | Proteolytic enzyme |
| Amylase | Amylolytic enzyme. |
| BTA | Benzotriazole |
| Sulphate | Anhydrous sodium sulphate. |
| PEG 3000 | Polyethylene Glycol molecular weight |
| | approximately 3000 available from Hoechst |
| PEG 6000 | Polyethylene Glycol molecular weight |
| | approximately 6000 available from Hoechst |
| PH | Measured as a 1% solution in distilled water at |
| | 20° C. |

Examples I to VI illustrate multi-phase detergent additive tablets of the present invention suitable for use as a laundry additive in a laundry washing machine.

| | I | II | III | IV | V | VI |
|---|---|---|---|---|---|---|
| Phase 1 | | | | | | |
| Percarbonate | 25.0 | 25.0 | 25.0 | 30.0 | 33.0 | 29.0 |
| TAED | 9.7 | 9.7 | 9.7 | 9.7 | 7.7 | 9.7 |
| Bleach Catalyst | 0.02 | 0.04 | — | — | — | — |
| Citric acid | 10.0 | 15.0 | 20.0 | 15.0 | 17.0 | 20.0 |
| STPP | — | — | — | — | — | 6.0 |
| Acrylic-Maleic | 6.0 | 6.0 | 1.0 | 5.0 | — | — |
| copolymer | | | | | | |
| Silicates | — | — | — | — | 6.0 | — |
| Bicarbonate | 15.0 | 15.0 | 10.0 | 15.0 | 15.0 | 15.0 |
| Carbonate | 5.0 | — | — | — | — | — |
| HEDP | — | — | — | 0.1 | — | 0.1 |
| DTPMP | — | — | — | — | 0.1 | — |
| ATMP | — | — | — | — | — | 0.1 |
| Brightener 49 ® | 0.11 | 0.11 | 0.11 | 0.11 | 0.11 | 0.11 |
| Perfume | 0.20 | 0.20 | 0.20 | 0.20 | 0.20 | 0.20 |
| C12-16 Fatty | — | — | — | 1.0 | — | — |
| acid | | | | | | |
| Protease - FN3 | 0.60 | 0.60 | 0.60 | 0.60 | 0.94 | 0.60 |
| Protease - | 0.34 | 0.34 | 0.34 | 0.34 | — | 0.34 |
| Savinase | | | | | | |
| Amylase - | 1.21 | 1.21 | 1.21 | 1.11 | 1.11 | 1.11 |
| Termamyl | | | | | | |
| PG2000-Na ® | 2.00 | 3.00 | 2.50 | 2.50 | 3.00 | 3.00 |
| Arbocel | 5.00 | — | — | — | — | — |
| FDY600 ® | | | | | | |
| Vivapur 200 ® | — | 5.00 | 5.00 | 5.00 | 5.00 | 5.00 |

Phase 2

| | | | | | | |
|---|---|---|---|---|---|---|
| Protease - FN3 | 1.24 | 1.24 | 1.24 | 1.24 | 1.24 | 1.24 |
| Amylase - JE1 | 1.34 | 1.34 | 1.34 | 1.34 | 1.34 | 1.34 |
| Blue PEG | 0.09 | 0.09 | 0.09 | 0.09 | 0.09 | 0.09 |
| PEG 4000 | 0.33 | 0.33 | 0.33 | 0.33 | 0.33 | 0.33 |
| Citric acid | 1.06 | 1.06 | 1.06 | 1.06 | 1.06 | 1.06 |
| Bicarbonate | 2.87 | 2.87 | 2.87 | 2.87 | 2.87 | 2.87 |

Brightener 49® available from Ciba Specialty Chemicals

Acrylic-Maleic copolymer having average molecular weight approximately 7000

Bleach Catalyst is a stable complex of Cobalt with NH3 and Acetate

The multi-phase tablet compositions are prepared as follows. The detergent active composition of phase 1 is prepared by admixing the granular and liquid components and is then passed into the die of a conventional rotary press. The press includes a punch suitably shaped for forming the mould. The cross-section of the die is approximately 30×38 mm. The composition is then subjected to a compression force of 940 kg/cm² and the punch is then elevated exposing the first phase of the tablet containing the mould in its upper surface. The detergent active composition of phase 2 is prepared in similar manner and is passed into the die. The particulate active composition is then subjected to a compression force of 170 kg/cm², the punch is elevated, and the multi-phase tablet ejected from the tablet press.

Examples VII to XI illustrate single-phase laundry detergent additive tablets of the present invention suitable for use in a laundry washing machine.

| | VII | VIII | IIX | IX | X | XI |
|---|---|---|---|---|---|---|
| Percarbonate | 20.0 | 20.0 | 25.0 | 34.0 | 35.0 | 19.0 |
| TAED | 9.7 | 9.7 | 9.7 | 9.7 | 7.7 | 9.7 |
| Bleach Catalyst | 0.02 | 0.04 | — | — | — | — |
| PG2000-Na ® | 2.0 | 3.0 | 2.5 | 2.5 | 2.5 | 2.0 |
| Arbocel | — | — | — | — | 5.00 | 4.00 |
| FDY600 ® | | | | | | |
| Vivapur 200 ® | 5.00 | 5.00 | 5.00 | 5.00 | | |
| Citric acid | 10.0 | 15.0 | 20.0 | 15.0 | 17.0 | 20.0 |
| STPP | — | — | — | — | — | 6.0 |
| Acrylic-Maleic | 6.0 | 6.0 | 1.0 | 5.0 | — | — |
| copolymer | | | | | | |
| Silicates | — | — | — | — | 6.0 | — |
| Bicarbonate | 15.0 | 15.0 | 10.0 | 15.0 | 15.0 | 15.0 |
| Carbonate | 5.0 | — | — | — | — | — |
| HEDP | — | — | — | 0.1 | — | 0.1 |
| DTPMP | — | — | — | — | 0.1 | — |
| ATMP | — | — | — | — | — | 0.1 |
| Brightener 49 ® | 0.11 | 0.11 | 0.11 | 0.11 | 0.11 | 0.11 |
| Perfume | 0.20 | 0.20 | 0.20 | 0.20 | 0.20 | 0.20 |
| C12-16 Fatty | — | — | — | 1.0 | — | — |
| acid | | | | | | |
| Protease - FN3 | 0.60 | 0.60 | 0.60 | 0.60 | 0.94 | 0.60 |
| Protease - | 0.34 | 0.34 | 0.34 | 0.34 | — | 0.34 |
| Savinase | | | | | | |
| Amylase - | 1.21 | 1.21 | 1.21 | 1.11 | 1.11 | 1.11 |
| Termamyl | | | | | | |
| Protease - FN3 | 1.24 | 1.24 | 1.24 | 1.24 | 1.24 | 1.24 |
| Amylase - JE1 | 1.34 | 1.34 | 1.34 | 1.34 | 1.34 | 1.34 |
| Blue PEG | 0.09 | 0.09 | 0.09 | 0.09 | 0.09 | 0.09 |
| PEG 4000 | 0.33 | 0.33 | 0.33 | 0.33 | 0.33 | 0.33 |
| Citric acid | 1.06 | 1.06 | 1.06 | 1.06 | 1.06 | 1.06 |
| Bicarbonate | 2.87 | 2.87 | 2.87 | 2.87 | 2.87 | 2.87 |

Brightener 49 ® available from Ciba Specialty Chemicals
Acrylic-Maleic copolymer having average molecular weight approximately 7000
Bleach Catalyst is a stable complex of Cobalt with NH3 and Acetate

What is claimed is:

1. A process of treating fabrics which comprises the steps of forming an aqueous bath comprising water, a conventional laundry detergent and a laundry detergent additive tablet and subsequently contacting said fabrics with said aqueous bath, wherein said laundry detergent additive tablet comprises an ion exchange resin.

2. A process according to claim 1 wherein said tablet has a concentration of ion exchange resin of greater than 0.1% by weight of the tablet.

3. A process according to claim 1, wherein said ion exchange resin is selected from the group consisting of weak anion exchange resins, strong anion exchange resins, weak cation exchange resins, strong cation exchange resins, and mixtures thereof.

4. A process according to claim 1, wherein said tablet further comprises a disintegration agent.

5. A process according to claim 4, wherein said disintegration agent is selected from the group consisting of: celluloses and derivatives thereof; microcrystalline cellulose; and mixtures thereof.

6. A process according to claim 4, wherein said tablet comprises from 0.5% to 15% by weight of said tablet of said disintegration agent.

7. A process according to claim 1, wherein said tablet further comprises a bleaching agent.

8. A process according to claim 7, wherein said bleaching agent is an inorganic perhydrate bleach.

9. A process according to claim 8, wherein said inorganic perhydrate bleach is percarbonate.

10. A process according to claim 7, wherein said tablet further comprises an alkyl percarboxylic bleach precursor.

11. A process according to claim 10, wherein said alkyl percarboxylic bleach precursor is tetracetyl ethylene diamine.

12. A process according to claim 7, wherein said tablet further comprises a metal containing bleach catalyst.

13. A process according to claim 1, wherein said tablet further comprises an enzyme.

14. A process according to claim 1, wherein said tablet is a multi-phase tablet.

15. A process according to claim 14, wherein said multi-phase tablet has two separate phases.
